(19) United States
(12) Patent Application Publication
(10) Pub. No.: US 2010/0185651 A1
(43) Pub. Date: Jul. 22, 2010

(54) RETRIEVING AND DISPLAYING INFORMATION FROM AN UNSTRUCTURED ELECTRONIC DOCUMENT COLLECTION

(75) Inventors: Daniel N. Crow, New York, NY (US); Daniel Loreto, New Rochelle, NY (US); Bogdan Caprita, New York, NY (US); Antonella Pavese, Norristown, PA (US); Jeffrey C. Reynar, NY, NY (US); Andrew William Hogue, Ho-Ho-Kus, NJ (US); Anthony J. Aiuto, Great Neck, NY (US); John Alexander Komoroske, New York, NY (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/355,228

(22) Filed: Jan. 16, 2009

(51) Int. Cl. G06F 17/30; G06F 15/16

(52) U.S. Cl. 707/769; 709/203; 707/E17.108; 707/758

(57) ABSTRACT

Methods, systems, and apparatus, including computer programs stored on computer storage media, for retrieval and display of information from an unstructured electronic document collection. One aspect can be embodied in machine-implemented methods that include the actions of receiving a machine-readable search query from a user and responding to the search query with instructions for presenting the user with a structured presentation of instances relevant to the search query. A visual presentation of the structured presentation denotes associations between the instances and values that characterize attributes of the instances by virtue of an arrangement of identifiers of the instances and the values.

### CROSS-REFERENCE TO RELATED APPLICATIONS

This specification refers to the commonly-owned U.S. patent applications entitled “POPULATING A STRUCTURED PRESENTATION WITH NEW VALUES” (Attorney Docket No. 16113-1218001), “ADDING NEW INSTANCES TO A STRUCTURED PRESENTATION” (Attorney Docket No. 16113-1219001), “ADDING NEW ATTRIBUTES TO A STRUCTURED PRESENTATION” (Attorney Docket No. 16113-1220001), and “EMBEDDING A CONCEALED SEARCH INTERFACE IN A STRUCTURED PRESENTATION” (Attorney Docket No. 16113-1551001), all of which are filed on the same day as the present disclosure and the contents of all of which are incorporated herein by reference.

### BACKGROUND

This specification relates to retrieving and displaying information from an unstructured electronic document collection.

An electronic document is a collection of machine-readable data. Electronic documents are generally individual files and are formatted in accordance with a defined format (e.g., PDF, TIFF, HTML, ASCII, MS Word, PCL, PostScript, or the like). Electronic documents can be electronically stored and disseminated. In some cases, electronic documents include audio content, visual content, and other information, as well as text and links to other electronic documents.

Electronic document can be collected into electronic document collections. Electronic document collections can either be unstructured or structured. The formatting of the documents in an unstructured electronic document collection is not constrained to conform with a predetermined structure and can evolve in often unforeseen ways. In other words, the formatting of individual documents in an unstructured electronic document collection is neither restrictive nor permanent across the entire document collection. Further, in an unstructured electronic document collection, there are no mechanisms for ensuring that new documents adhere to a format or that changes to a format are applied to previously existing documents. Thus, the documents in an unstructured electronic document collection cannot be expected to share a common structure that can be exploited in the extraction of information. Examples of unstructured electronic document collections include the documents available on the Internet, collections of resumes, collections of journal articles, and collections of news articles. Documents in some unstructured electronic document collections are not prohibited from including links to other documents inside and outside of the collection.

In contrast, the documents in structured electronic document collections generally conform with formats that can be both restrictive and permanent. The formats imposed on documents in structured electronic document collections can be restrictive in that common formats are applied to all of the documents in the collections, even when the applied formats are not completely appropriate. The formats can be permanent in that an upfront commitment to a particular format by the party who assembles the structured electronic document collection is generally required. Further, users of the collections—in particular, programs that use the documents in the collection—rely on the documents' having the expected format. As a result, format changes can be difficult to implement. Structured electronic document collections are best suited to applications where the information content lends itself to simple and stable categorizations. Thus, the documents in a structured electronic document collection generally share a common structure that can be exploited in the extraction of information. Examples of structured electronic document collections include databases that are organized and viewed through a database management system (DBMS) in accordance with hierarchical and relational data models, as well as a collections of electronic documents that are created by a single entity for presenting information consistently. For example, a collection of web pages that are provided by an online bookseller to present information about individual books can form a structured electronic document collection. As another example, a collection of web pages that is created by server-side scripts and viewed through an application server can form a structured electronic document collection. Thus, one or more structured electronic document collections can each be a subset of an unstructured electronic document collection.

### SUMMARY

This specification describes technologies relating to retrieval and display of information from an unstructured electronic document collection, for example, the electronic documents available on the Internet. Although an electronic document collection may be unstructured, the information content of the unstructured electronic document collection can be displayed in a structured presentation. In particular, the information content of an unstructured electronic document collection can be used not only to determine the values of attributes but also to identify, select, and name attributes and instances in a structured presentation. Such structured presentations can present information in a coherent manner to a user despite the diversity in sources. Examples of structured presentations include tables and other collections of records.

In general, one aspect of the subject matter described in this specification can be embodied in machine-implemented methods that include the actions of receiving a machine-readable search query from a user and responding to the search query with instructions for presenting the user with a structured presentation of instances relevant to the search query. A visual presentation of the structured presentation denotes associations between the instances and values that characterize attributes of the instances by virtue of an arrangement of identifiers of the instances and the values. The identifiers of the instances and the values are drawn from two or more documents in an unstructured collection of electronic documents. The electronic document collection being unstructured in that the format of the electronic documents in the electronic document collection is neither restrictive nor permanent.

This and other aspects can include one or more of the following features. Responding to the search query can include identifying a first collection of electronic documents in the unstructured collection that relate to the instances, extracting values of the attributes of the instances from the first collection of electronic documents, and populating the structured presentation with the values extracted from two or more electronic documents. Responding to the search query can include extracting a first value of a first attribute of a first instance from a first electronic document, extracting a second value of a second attribute of the first instance from a second electronic document, and associating the first value and the second value with the first instance in a single in the structured presentation. The first attribute can differ from the second attribute and the first electronic document can differ from the second electronic document.

Responding to the search query can include extracting a first value of an attribute of a first instance from a first electronic document, extracting a second value of an attribute of a second instance from the first electronic document, associating the first value with the first instance in a first record, and associating the second value in with the second instance in a second record. The first instance can differ from the second instance. The structured presentation can include a table and the records can include rows or columns of the table. The structured presentation can include a collection of cards and the records can be individual cards in the collection.

The method can also include receiving a trigger for the addition of a new instance to the structured presentation and suggesting new instances for addition to the structured presentation in response to the trigger. The method can also include receiving a specification of a constraint from a user and suggesting new instances comprises suggesting new instances that satisfy the user-specified constraint. The method can include receiving a trigger for the addition of a new attribute to the structured presentation and adding a new attribute to the structured presentation in response to the trigger.

The method can also include receiving a user specification of a trait of the new attribute and populating the structured presentation with values of the attribute based on the user-specified trait. The unstructured electronic document collection can include electronic documents available on the Internet. The structured presentation can be physically presented on a display screen, including physically transforming one or more elements of the display screen.

Other embodiments of this aspect include corresponding systems, apparatus, and computer programs recorded on computer storage devices, each configured to perform the operations of the methods.

Another aspect of the subject matter described in this specification can be embodied in an apparatus that includes one or more machine-readable data storage media storing instructions operable to cause one or more data processing machines to perform operations. The operations can include receiving description data describing a preexisting structured presentation, drawing an identifier of a first instance from a first web site, drawing a first value of a first attribute of the first instance from a second web site, adding the identifier of a first instance and the new value to the preexisting structured presentation to form a new record in a new structured presentation, and outputting instructions for visually presenting the new structured presentation. A visual presentation of the preexisting structured presentation visually presenting information in a systematic arrangement that conforms with a structured design. The structured presentation denotes associations between an instance and values that characterize attributes of the instance by virtue of an arrangement of an identifier of the instance and the values in a visual presentation of the structured presentation.

This and other aspects can include one or more of the following features. Drawing the identifier of the first instance from the first web site can include comparing characteristics of the preexisting structured presentation with content of the preexisting structured presentation. The operations can also include receiving an identifier of a second instance from the user. The new structured presentation can include a second new record that presents the second instance in association with a second value of the first attribute of the second instance. The operations can include receiving the second value from the user.

A collection of candidate values can be presented to the user and a selection of a second value can be received from the user. The collection of candidate values an include the second value. A collection of candidate values of the first attribute of the second instance can be identified and, for each of the candidate values, a confidence that the candidate value is correct can be determined.

The operations can include suggesting a collection of new instances to be added to the structured presentation. The collection of new instances can be suggested by comparing characteristics of the preexisting structured presentation with content of the first web site and the second web site and/or by comparing a machine-readable search query with content of the first web site and the second web site.

Drawing the first value from the second web site can include identifying that the second web site includes a review, extracting the identifier directly from the first web site, or extracting the identifier from a machine-readable database that includes information extracted from the first web site. The preexisting structured presentation can include a table and the records can include rows or columns of the table. The preexisting structured presentation can include a collection of cards and the records can be individual cards in the collection. The operations can include visually displaying the new structured presentation on a display screen, including physically transforming one or more elements of the display screen.

Other embodiments of this aspect include corresponding systems, apparatus, and methods.

In another aspect, a system includes a client device and one or more computers programmed to interact with the client device and to perform operations. The operations include receiving description data describing a preexisting structured presentation, drawing an identifier of a first instance from a first web site, drawing a first value of a first attribute of the first instance from a second web site, adding the identifier of a first instance and the new value to the preexisting structured presentation to form a new record in a new structured presentation, and outputting to the client device instructions for visually presenting the new structured presentation. A visual presentation of the preexisting structured presentation visually presents information in a systematic arrangement that conforms with a structured design. The structured presentation including a collection of records, each of which denotes associations between an instance and values that characterize attributes of the instance by virtue of an arrangement of an identifier of the instance and the values in a visual presentation of the structured presentation.

This and other aspects can include one or more of the following features. The one or more computers can include a server operable to interact with the client device through a data communication network, and the client device is operable to interact with the server as a client.

Other embodiments of this aspect include corresponding systems, apparatus, and methods.

In another aspect, a system includes a client device and one or more computers programmed to interact with the client device and to perform operations. The operations include receiving a machine-readable search query from the client device and responding to the search query by sending to the client device instructions for presenting a structured presentation of instances relevant to the search query. A visual presentation of the structured presentation denotes associations between the instances and values that characterize attributes of the instances by virtue of an arrangement of identifiers of the instances and the values. The identifiers of the instances and the values are drawn from two or more documents in an unstructured collection of electronic documents. The electronic document collection being unstructured in that the format of the electronic documents in the electronic document collection is neither restrictive nor permanent.

This and other aspects can include one or more of the following features. The one or more computers can include a server operable to interact with the client device through a data communication network, and the client device is operable to interact with the server as a client.

Other embodiments of this aspect include corresponding systems, apparatus, and methods.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a system in which information from an electronic document collection is presented to a user in a structured presentation.

FIG. 2 is a schematic representation of an implementation of another system in which information from an electronic document collection is presented to a user in a structured presentation.

FIGS. 3, 4, 5 are schematic representations of example structured presentations.

FIG. 6 is a flow chart of an example process for presenting information from an electronic document collection to a user in a structured presentation.

FIGS. 7 and 8 are flow charts of example processes for identifying two or more relevant documents in an electronic document collection.

FIG. 9 is a flow chart of a process for suggesting and/or adding new instances to a structured presentation

FIG. 10 is a schematic representation of a user interface component for receiving user input specifying modifications of a structured presentation.

FIG. 11 is schematic representation of a user interface component for receiving user input specifying a technique for adding new instances to a structured presentation.

FIG. 12 is schematic representation of a user interface component for receiving user input specifying constraints that are to be used in the user-specified constraint option for adding new instances to a structured presentation.

FIG. 13 is a flow chart of an example process for adding new attributes to a structured presentation.

FIG. 14 is schematic representation of a user interface component for adding new attributes to a structured presentation.

FIG. 15 is a flow chart of an example process for adding new attribute values to a structured presentation.

FIG. 16 is a flow chart of an example process for adding new attribute values to a structured presentation.

FIG. 17 is a schematic representation of a user interface component for selecting a candidate value to be added to a structured presentation.

FIG. 18 a schematic representation of a structured presentation that includes highlights of deficiencies in the attribute values presented therein.

FIG. 19 is a schematic representation of a user interface component for selecting a candidate attribute to be added to a structured presentation.

FIG. 20 is a schematic representation of a user interface component for selecting a candidate instance to be added to a structured presentation.

Like reference symbols in the various drawings indicate like elements.

### DETAILED DESCRIPTION

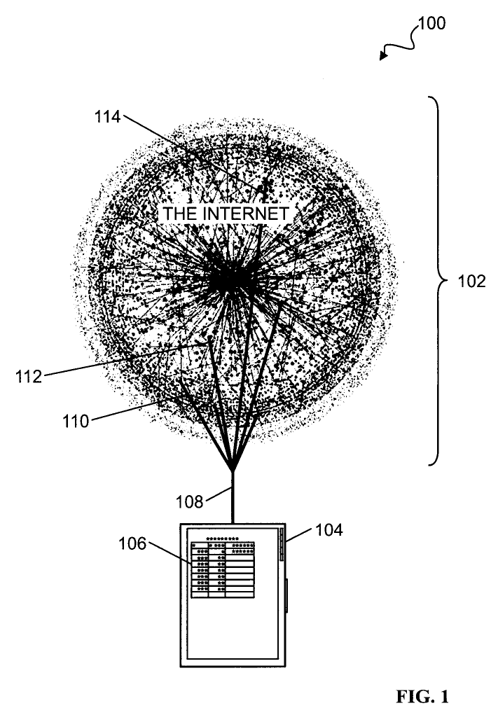

FIG. 1 is a schematic representation of a system 100 in which information from an unstructured electronic document collection 102 is presented to a user in a structured presentation 106. In addition to electronic document collection 102, system 100 includes a display screen 104 and a data communication infrastructure 108. In operation, system 100 extracts information from unstructured collection of electronic documents 102 and presents the extracted information in a structured presentation 106 on display screen 104.

Electronic document collection 102 is unstructured in that the organization of information within individual documents in electronic document collection 102 need not conform with a predetermined structure that can be exploited in the extraction of information. For example, consider three electronic documents in electronic document collection 102, namely, electronic documents 110, 112, 114. Documents 110, 112, 114 were added to collection 102 by three different users who organize the content of their respective electronic documents differently. The users need not collaborate to ensure that information within documents 110, 112, 114 is in a particular format. Moreover, if one user wishes to change the format of document 110, the user can do so without regard for the format of the documents added by the other users. There is no need for the user to inform the other users of the change. Indeed, in some cases, documents can be added to collection 102 by entities who not only fail to collaborate but who are also competitors who are adverse to one another, such as three different car manufacturers or three different sellers of digital cameras. Regardless of the particular alignment of the entities who add documents to collection 102, there is no formal mechanism for insuring that the information in documents is similarly organized within the documents. Further, there is no formal mechanism for ensuring that the organization of information in each of each document in collection 102 remains unchanged.

In contrast, structured presentation 106 is structured and presents information drawn from documents in collection 102 in an organized, systematic arrangement. Thus, the grouping, segmentation, and arrangement of information in structured presentation 106 conforms with a structured design even when the information therein is drawn from different contexts in a diverse set of documents in collection 102. Further, changes to one aspect of the design of structured presentation 106 can be propagated throughout structured presentation 106.

Examples of structured presentations include spreadsheet tables, collections of cards or other records, and other structured presentation formats. Such structured presentations can conform with rules that specify the spatial arrangement of information in the displays, the positioning and identification of various organizational and informational aspects (e.g., column headers, row headers, unit identifiers, and the like) of the structured presentations, the graphical representation of values, and other characteristics.

The structuring of information in structured presentations generally facilitates the understanding of the information by a viewer. For example, a viewer can discern the nature of the information contained within the structured presentation by reading headers. A viewer of can easily identify and compare values described in the structured presentation based on the arrangement and positioning of those values in the display. For example, a user can easily ascertain that certain values in a structured presentation all relate to attributes (i.e., characteristics) of different cars and can easily compare those values.

System 100 is not limited to merely populating structured presentation 106 with values drawn from documents in collection 102. Instead, in many implementations, system 100 can determine entities (i.e., “instances”) that are to be described in structured presentation 106, values that characterize the attributes of those instances, as well as an appropriate structuring of structured presentation 106. Such determinations can be based on information drawn from different documents in collection 102 that are not restricted to having a specific format, a permanent format, or both. For example, the attributes that appear in structured presentation 106 can be based on the attributes used in documents in collection 102 to characterize certain instances, as discussed further below. As another example, the units of the values (e.g., meters, feet, inches, miles) that appear in structured presentation 106 can be based on the units of the values that appear documents in collection 102. As another example, the instances that appear in structured presentation 106 can be determined based on collections of instances that appear in documents in collection 102.

Further, in many implementations, such information can be drawn from previously unspecified documents in collection 102. For example, a search query can be used to identify documents in collection 102 and the information can be drawn from these documents. There need not be preexisting limits on the identity or type of documents from which information can be drawn. For example, the identified documents need not be limited to being associated with the account of a particular individual or originating from a particular retailer. Instead, the information can be drawn from previously unspecified documents.

System 100 can thus exploit the diverse information content of documents in collection 102 in a variety of different ways to present a structured presentation to a user. In cases where electronic document collection 102 includes a large number of documents, the amount of information that can be exploited can be very large. Moreover, in many cases, this can be done automatically or with a relatively small amount of human interaction, as discussed further below.

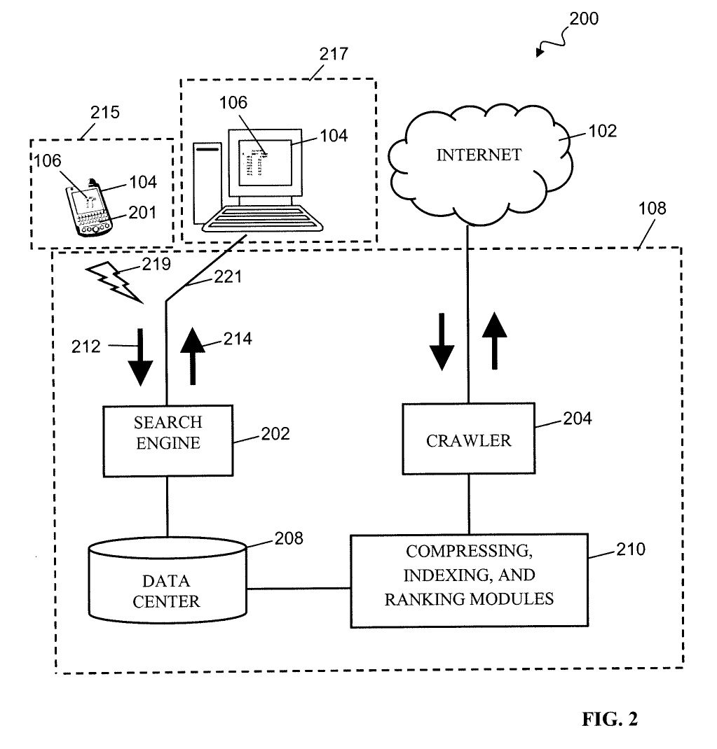

FIG. 2 is a schematic representation of an implementation of a system 200 in which information from an unstructured electronic document collection 102 is presented to a user in a structured presentation 106. In system 200, the data communication infrastructure 108 interconnects electronic document collection 102, display screen 104, and a collection of data storage and processing elements, including a search engine 202, a crawler 204, a data center 208, and document compressing, indexing and ranking modules 210.

Search engine 202 is programmed with one or more sets of machine-readable instructions for searching unstructured electronic document collection 102. Search engine 202 can be implemented on one or more computers deployed at one or more geographical locations.

Crawler 204 is programmed with one or more sets of machine-readable instructions for crawling unstructured electronic document collection 102. Crawler 204 can be implemented on one or more computers deployed at more or more geographical locations.

Compressing, indexing, and ranking modules 210 are programmed with one or more sets of machine-readable instructions for compressing, indexing, and ranking documents in collection 102. Compressing, indexing, and ranking modules 210 can be implemented on one or more computers deployed at more or more geographical locations.

The data center 208 stores information characterizing electronic documents in electronic document collection 102. The information characterizing such electronic documents can be stored in the form of an indexed database that includes indexed keywords and the locations of documents in collection 102 where the keywords can be found. The indexed database can be formed, e.g., by crawler 204.

In some implementations, the information stored in data center 208 can itself be organized to facilitate presentation of structured presentation 106 to a user. For example, information can be organized by crawler 204 and compressing, indexing and ranking modules 210 in anticipation of the need to present structured presentations 106 that are relevant to certain topics. The structure of information in data center 208 can facilitate the grouping, segmentation, and arrangement of information in structured presentations 106. This organization can be based on a variety of different factors. For example, an ontology can be used to organize information stored in data center 208. As another example, a historical record of previous structured presentations 106 can be used to organize information stored in data center 208. As another example, the data tables described herein can be used to organize information stored in data center 208.

As shown, system 200 includes multiple display screens 104 that can present structured presentations in accordance with machine-readable instructions. Display screens 104 can include, e.g., cathode ray tubes (CRT's), light emitting diode (LED) screens, liquid crystal displays (LCD's), gas-plasma displays, and the like. Display screens 104 can be an integral part of a self-contained data processing system, such as a personal data assistant (PDA) 215, a desktop computer 217, or a mobile telephone. In general, instructions for presenting structured presentations are modified to the particularities of a display screen 104 after receipt by such a self-contained data processing system. However, this is not always the case. For example, display screens 104 can also be part of more disperse systems where the processing of instructions for presenting a structured presentation is completed before the instructions are received at display screen 104. For example, display screens 104 can be incorporated into “dumb” devices, such as television sets or computer monitors, that receive instructions for presenting structured presentation 106 from a local or remote source.

In operation, system 200 can transform the unstructured information in collection 102 into structured presentation 106 that is presented to a viewer. Such transformations can be performed in the context of web search in which a search engine receives and responds to information requests based on information extracted from the electronic documents in collection 102.

For example, personal data assistant (PDA) 215 or desktop computer 217 can interact with a user and thereby receive a search query, e.g., by way of a web browser application. A description 212 of the query can be transmitted over a wireless data link 219 and/or a wired data link 221 to search engine 202. In response, search engine 202 can use query description 212 to identify information in data center 208 that can be used in presenting structured presentation 106 on display screen 104. The identified information can be drawn from two or more unspecified electronic documents in unstructured electronic document collection 102. In some instances, query description 212 can include search terms that are used by search engine 202 to retrieve information for presenting a structured presentation 106 to a user. For example, search terms in query description 212 can be used to identify, in data center 208, a collection of related instances, attributes that characterize such instances, value that characterize the individual instances, and/or other aspects of structured presentation 106.

The search engine 202 can also generate a response 214 to query description 212. The response 214 can be used to present structured presentation 106 for a user. In general, response 214 includes machine readable-instructions that can be interpreted by a data processing device in systems 215, 217 to present structured presentation 106. For example, response 214 can be coded in HTML to specify the characteristics and content of structured presentation 106. In other implementations, response 214 can include text snippets or other information from data center 208 that is used in presenting structured presentation 106. For example, response 214 can include a collection of values, the name of a new attribute, or an estimate of the likelihood that a value to be displayed in structured presentation 106 is correct, as discussed further below.

In many cases, system 200 uses the information stored in data center 208 to identify the location of one or more documents that are relevant to the query described in query description 212. For example, search engine 202 can compare the keywords in query description 212 to an index of keywords stored in data center 208. The comparison can be used to identify documents in collection 102 that are relevant to query description 212. The locations of such identified documents can be included in responses 214, e.g., as a hyperlink to the documents that are that are responsive to the described query.

In some implementations, the system 200 can store attributes and/or their respective values in a manner that facilitates the grouping, segmentation, and arrangement of information in structured presentations 106. For example, collections of instances, their attributes, and their values can be stored in data center 208 as structured presentations 106 are amended and changed by users interacting with client systems such as systems 215, 217. For example, instances, attributes, and values in one structured presentation 106 presented to a first viewer can be stored in the data center 208 and used in providing subsequent structured presentations 106 to other viewers.

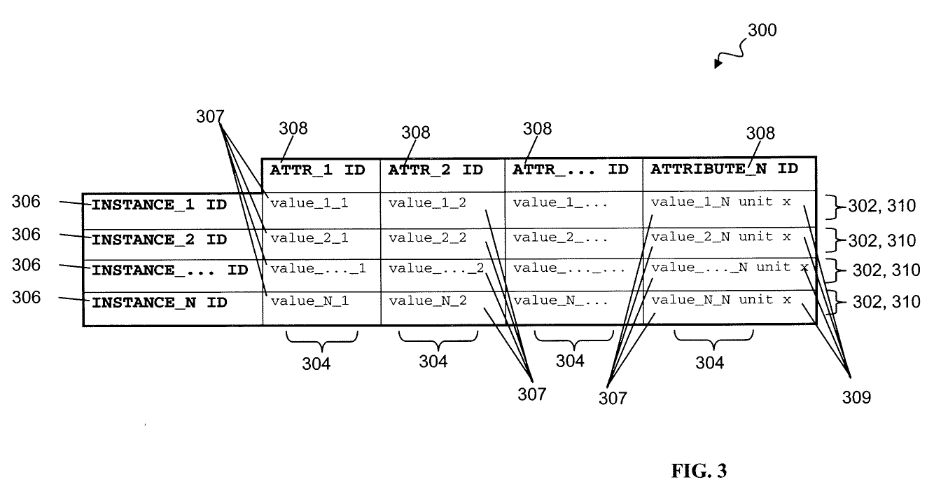

FIG. 3 is a schematic representation of an example structured presentation 106, namely, one that includes a table 300. Table 300 is an organized, systematic arrangement of one or more identifiers of instances, as well as the values of particular attributes of those instances. Instances are individually identifiable entities and generally share at least some common attributes. An attribute is a property, feature, or characteristic of an entity. For example, Tom, Dick, and Harry are instances of individuals. Each such individual has attributes such as a name, a height, a weight, and the like. As another example, city instances each have a geographic location, a mayor, and a population. As yet another example, a product instance can have a model name, a maker, and a year.

The attributes of an instance can be characterized by values. The values of a particular attribute of a particular instance thus characterize that particular instance. For example, the name of an individual can have the value “Tom,” the population of a city can have the value “4 million,” and the model name of a product can have the value “Wrangler.” In some implementations, structured presentations such as table 300 can also include identifiers of attributes, as well as identifiers of the units in which values are expressed.

The grouping, segmentation, and arrangement of information in table 300 can be selected to facilitate understanding of the information by a user. In this regard, table 300 includes a collection of rows 302. Each row 302 includes an instance identifier 306 and a collection of associated attribute values 307. The arrangement and positioning of attribute values 307 and instance identifiers 306 in rows 302 thus graphically represents the associations therebetween. For example, a user can discern the association between attribute values 307 and the instance identifier 306 that is found in the same row 302.

Table 300 also includes a collection of columns 304. Each column 304 includes an attribute identifier 308 and a collection of associated attribute values 307. The arrangement and positioning of attribute values 307 and attribute identifier 308 in columns 304 thus graphically represent the associations therebetween. For example, a user can discern the association between attribute values 307 and the attribute identifier 308 that is found in the same column 304 based on their alignment.

Each row 302 is a structured record 310 in that each row 302 associates a single instance identifier 306 with a collection of associated attribute values 307. Further, the arrangement and positioning used to denote these associations in one structured record 310 is reproduced in other structured records 310 (i.e., in other rows 302). Indeed, in many cases, all of the structured records 310 in a structured presentation 106 are restricted to having the same arrangement and positioning of information. For example, values 307 of the attribute “ATTR_{—}2” are restricted to appearing in the same column 304 in all rows 302. As another example, attribute identifiers 308 all bear the same spatial relationship to the values 307 appearing in the same column 304. Moreover, changes to the arrangement and positioning of information in one structured record 310 are generally propagated to other structured record 310 in the structured presentation 106. For example, if a new attribute value 307 that characterizes a new attribute (e.g., “ATTR_{—}2¾”) is added to one structured record 310, then a new column 304 is added to structured presentation 106 so that the values of attribute “ATTR_{—}2¾” of all instances can be added to structured presentation 106.

In some implementations, values 307 in table 300 can be presented in certain units of measure. Examples of units of measure include feet, yards, inches, miles, seconds, gallons, liters, degrees Celsius, and the like. In some instances, the units of measure in which values 307 are presented are indicated by unit identifiers 309. Unit identifiers 309 can appear, e.g., beside values 307 and/or beside relevant attribute identifiers 308. The association between unit identifiers 309 and the values 307 whose units of measure are indicated is indicated to a viewer by such positioning. In many cases, all of the values 307 associated with a single attribute (e.g., all of the values 307 in a single column 304) are restricted to being presented in the same unit of measure.

The information extracted from electronic document collection 102 by systems 100, 200 can impact the presentation of table 300 to a user in a variety of different ways. For example, the information extracted from electronic document collection 102 can be used to determine values 307 for populating table 300. As another example, the information extracted from electronic document collection 102 can be used to suggest new attributes and/or new instances for addition to table 300.

In some implementations, instance identifiers 306 can be selected based on one or more search strings. For example, if the search string “hybrid vehicles” is received from a user by search engine 202, systems such as system 200 can generate and populate table 300 based on information extracted from electronic document collection 102 using the search string. For example, system 200 can access data center 208, identify instance identifiers 306 in the electronic documents that are relevant to the search string, determine a set of common attributes for the identified instances—as well as identifiers 308 of those attributes and values 307 for those attributes. In effect, system 200 can determine instance identifiers 306, attribute identifiers 308, as well as the associated values 307 based on the received search string.

In some implementations, one or more attribute identifiers 308, instance identifiers 306, and/or values 307 can be received from a user for whom table 300 is to be displayed. As discussed further below, systems such as system 200 can generate and populate table 300 based on information extracted from electronic document collection 102 using one or more received attribute identifiers 308, instance identifiers 306, and/or values 307. In effect, system 200 can formulate new instance identifiers 306, attribute identifiers 308, as well as the associated values 307 based on the received attribute identifiers 308, instance identifiers 306, and/or values 307.

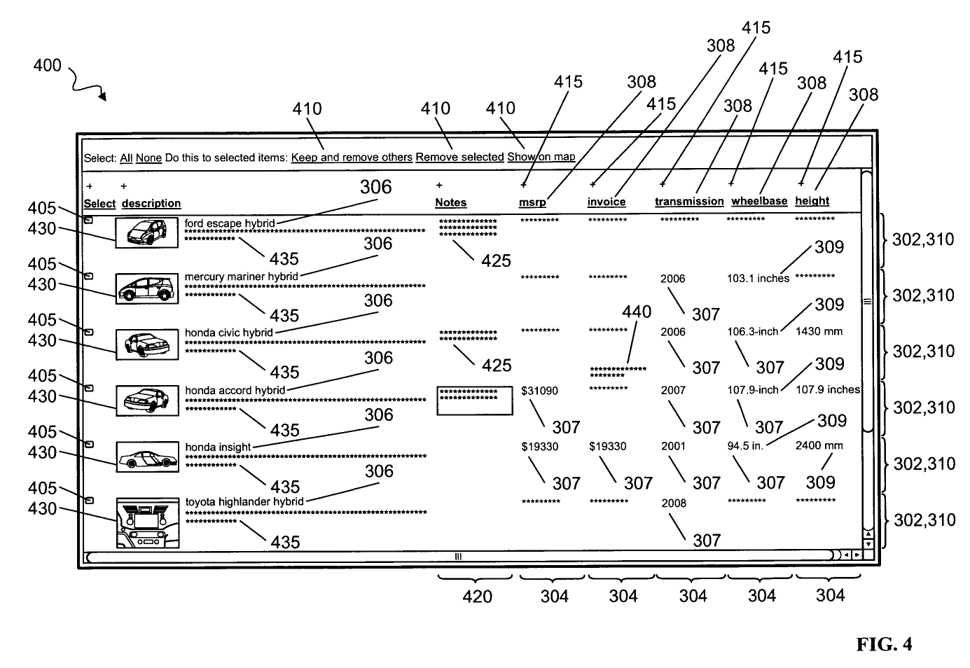

FIG. 4 is a schematic representation of another implementation of a structured presentation, namely, one that includes a table 400. In addition to including attribute identifiers 308, instance identifiers 306, values 307, unit identifiers 309 organized into rows 302 and columns 304, table 400 also includes a number of interactive elements for interacting with a user. In particular, table 400 includes a collection of instance selection widgets 405, a collection of action triggers 410, a collection of column action trigger widgets 415, and a notes column 420.

Instance selection widgets 405 are user interface components that allow a user to select structured records 310 in table 400. For example, instance selection widgets 405 can be a collection of clickable checkboxes that are associated with a particular structured record 310 by virtue of arrangement and positioning relative to that structured record 310. Instance selection widgets 405 are “clickable” in that a user can interact with widgets 405 using a mouse (e.g., hovering over the component and clicking a particular mouse button), a stylus (e.g., pressing a user interface component displayed on a touch screen with the stylus), a keyboard, or other input device to invoke the functionality provided by that component.

Action triggers 410 are user interface components that allow a user to trigger the performance of an action on one or more structured records 310 in table 400 selected using instance selection widgets 405. For example, action triggers 410 can be clickable text phrases, each of which can be used by a user to trigger an action described in the phrase. For example, a “keep and remove others” action trigger 410 triggers the removal of structured records 310 that are not selected using instance selection widgets 405 from the display of table 400. As another example, a “remove selected” action trigger 410 triggers the removal of structured records 310 that are selected using instance selection widgets 405 from the display of table 400. As yet another example, a “show on map” action trigger 410 triggers display of the position of structured records 310 that are selected using instance selection widgets 405 on a geographic map. For example, if a selected instance is a car, locations of car dealerships that sell the selected car can be displayed on a map. As another example, if the selected instances are spring break destinations, these destinations can be displayed on a map.

Column action trigger widgets 415 are user interface components that allow a user to apply an action to all of the cells within a single column 304. When a user interacts with the clickable ‘+’ sign, a further user interface component is displayed which offers to the user a set of possible actions to be performed. The actions in this set can include, e.g., removing the entire column 304 from the structured presentation 400 or a search to find values for all the cells in column 304 which are currently blank.

Notes column 420 is a user interface component that allows a user to associate information with an instance identifier 306. In particular, notes column 420 includes one or more notes 425 that are each associated with a structured record 310 by virtue of arrangement and positioning relative to that structured record 310. The information content of notes 425 is unrestricted in that, unlike columns 304, notes 425 are not alleged to be values of any particular attribute. Instead, the information in notes 425 can characterize unrelated aspects of the instance identified in structured record 310.

In some implementations, table 400 can include additional information other than values of any particular attribute. For example, table 400 can include a collection of images 430 that are associated with the instance identified in a structured record 310 by virtue of arrangement and positioning relative to that structured record 310. As another example, table 400 can include a collection of text snippets 435 extracted from electronic documents in collection 102. The sources of the snippets can be highly ranked results in searches conducted using instance identifiers 306 as a search string. Text snippets 435 are associated with the instance identified in a structured record 310 by virtue of arrangement and positioning relative to that structured record 310.

As another example, table 400 can include one or more hypertext links 440 to individual electronic documents in collection 102. For example, the linked documents can be highly ranked results in searches conducted using instance identifiers 306 as a search string. As another example, the linked documents can be source of a value 307 that was extracted to populate table 400. In some instances, interaction with hypertext link 440 can trigger navigation to the source electronic document based on information embedded in hypertext link 440 (e.g., a web site address).

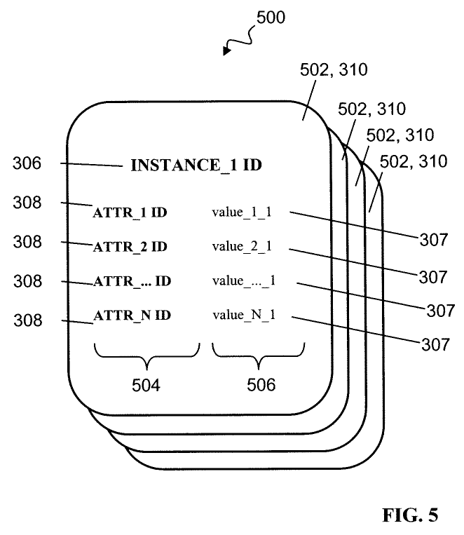

FIG. 5 is a schematic representation of another implementation of a structured presentation, namely, a collection of cards 500. Card collection 500 is an organized, systematic arrangement of one or more identifiers of instances, as well as the values of particular attributes of those instances. The attributes of an instance can be specified by values. Moreover, card collection 500 generally includes identifiers of attributes, as well as identifiers of the units in which values are expressed, where appropriate.

The grouping, segmentation, and arrangement of information in card collection 500 can be selected to facilitate an understanding of the information by a user. In this regard, card collection 500 includes a collection of cards 502. Each card 502 includes an instance identifier 306 and a collection of associated attribute values 307. The arrangement and positioning of attribute values 307 and instance identifiers 306 in cards 502 thus graphically represents the associations therebetween. For example, a user can discern the association between attribute values 307 and the instance identifier 306 that is found on the same card 502.

In the illustrated implementation, cards 502 in card collection 500 also include a collection of attribute identifiers 308. Attribute identifiers 308 are organized in a column 504 and attribute values 307 are organized in a column 506. Columns 504, 506 are positioned adjacent one another and aligned so that individual attribute identifiers 308 are positioned next to the attribute value 307 that characterizes that identified attribute. This positioning and arrangement allows a viewer to discern the association between attribute identifiers 308 and the attribute values 307 that characterize those attributes.

Each card 502 is a structured record 310 in that each card 502 associates a single instance identifier 306 with a collection of associated attribute values 307. Further, the arrangement and positioning used to denote these associations in one card 502 is reproduced in other cards 502. Indeed, in many cases, all of the cards 502 are restricted to having the same arrangement and positioning of information. For example, the value 307 that characterizes the attribute “ATTR_{—}1” is restricted to bearing the same spatial relationship to instance identifiers 306 in all cards 502. As another example, the order and positioning of attribute identifiers 308 in all of the cards 502 is the same.

Moreover, changes to the arrangement and positioning of information in one card 502 are generally propagated to other cards 502 in card collection 500. For example, if a new attribute value 307 that characterizes a new attribute (e.g., “ATTR_{—}1¾”) is inserted between the attribute values “value_{—}1_{—}1” and “value_{—}2_{—}1” in one card 502, then the positioning of the corresponding attribute values 307 in other cards 502 is likewise changed.

In some implementations, cards 502 in card collection 500 can include other features. For example, cards 502 can include interactive elements for interacting with a user, such as instance selection widgets, action triggers, attribute selection widgets, a notes entry, and the like. As another example, cards 502 in card collection 500 can include additional information other than values of any particular attribute, such as images and/or text snippets that are associated with an identified instance. As another example, cards 502 in card collection 500 can include one or more hypertext links to individual electronic documents in collection 102. Such features can be associated with particular instances by virtue of appearing on a card 502 that includes an instance identifier 306 that identifies that instance.

During operation, a viewer can interact with the system presenting card collection 500 to change the display of one or more cards 502. For example, a viewer can trigger the side-by-side display of two or more of the cards 502 so that a comparison of the particular instances identified on those cards is facilitated. As another example, a viewer can trigger a reordering of card 502, an end to the display of a particular card 502, or the like. As another example, a viewer can trigger the selection, change, addition, and/or deletion of attributes and/or instances displayed in cards 502. As yet another example, a viewer can trigger a sorting of cards into multiple piles according to, e.g., the values of an attribute values 307 in the cards.

In some implementations, cards 502 will be displayed with two “sides.” For example, a first side can include a graphic representation of the instance identified by instance identifier 306, while a second side can include instance identifier 306 and values 307. This can be useful, for example, if the user is searching for a particular card in the collection of cards 500, allowing the user to identify the particular card with a cursory review of the graphical representations on the first side of the cards 502.

FIG. 6 is a flow chart of an example process 600 for presenting information from an electronic document collection to a user in a structured presentation. Process 600 can be performed by one or more computers that perform operations by executing one or more sets of machine-readable instructions. For example, process 600 can be performed by the search engine 202 in system 200. In some implementations, process 600 can be performed in response to the receipt of a trigger, such as a user request to create or change a structured presentation.

The system performing process 600 can identify two or more responsive electronic documents in the electronic document collection (step 605). The responsive documents can be identified in a number of different ways. In some instances, documents are identified based on “new” information—such as, e.g., a new search query—received from viewer. For example, the system can compare a newly received search query with the content of the electronic documents in the electronic document collection using string comparisons. As another example, the system can access a data center such as data center 208 and compare the terms in a search query with an index of keywords to identify the location of responsive electronic documents.

In some instances, documents are identified based on “old” information that is already found in a structured presentation. Among the information found in a structured presentation are the identities of instances, attributes, values, and the units in which the values are represented. The system performing process 600 can use this old information to identify responsive electronic documents in the electronic document collection. For example, documents that include instances already found in a structured presentation can be identified as responsive. As another example, documents that characterize instances using attributes already found in a structured presentation can be identified as responsive. Additional examples of such identifications are discussed further below.

The system performing process 600 can also gather information from the identified electronic documents (step 610). The gathered information can regard one or more instances, attributes, and/or values. The system performing process 600 can gather this information directly from the documents in an electronic document collection or from previously assembled collections of information that characterize the electronic documents in an electronic document collection. For example, in the context of system 200 (FIG. 2), the system performing process 600 can locate documents in collection 102, access the located documents, and extract the information directly from the original documents in collection 102. As another example in the context of system 200 (FIG. 2), the system performing process 600 can access a collection of information in data center 208 and gather the information from, e.g., a database that includes an index of keywords and the location of documents that include those keywords, an ontology, and/or a historical record of previous structured presentations that were presented using information extracted from documents in collection 102.

The system performing process 600 can use the gathered information to provide instructions for presenting structured presentations based on the gathered information (step 615). For example, the system performing process 600 can generate machine-readable instructions for presenting a structured presentation such as tables 300, 400 or collection of cards 500.

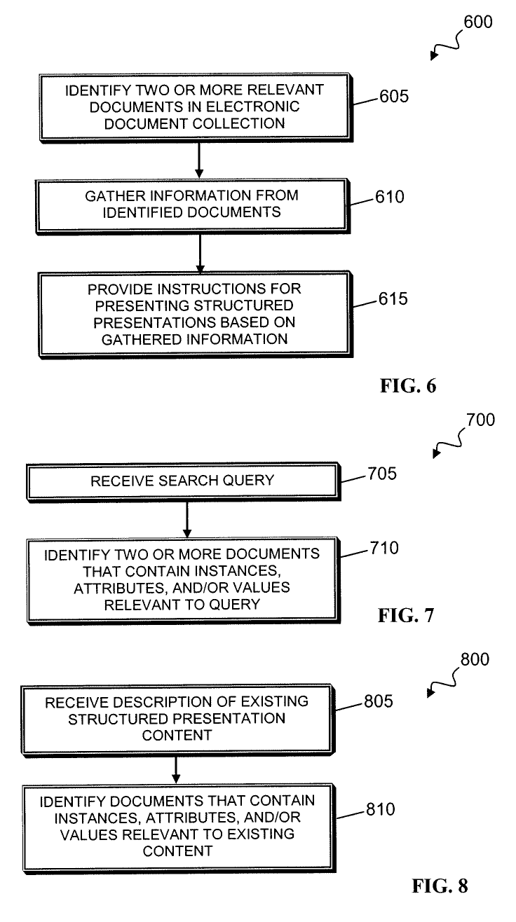

FIG. 7 is a flow chart of an example process 700 for identifying responsive documents in an electronic document collection. Process 700 can be performed in isolation or in conjunction with other data processing activities. For example, process 700 can be performed at step 605 in process 600 (FIG. 6).

The system performing process 700 receives a search query (step 705). For example, the system can receive one or more search strings (e.g., “hybrid vehicles”) from a user. As another example, the system can receive a search string from another process or system. In some implementations, the search string is received through an application programming interface (API), a common gateway interface (CGI) script, or other programming interfaces. In other implementations, the search string is received through a web portal, a web page, or web site, or the like.

In response, the system performing process 700 identifies two or more documents that contain instances, attributes, and/or values that are responsive to the search query (step 710). The documents can be identified by classifying the role that terms in the search query are to play in a structured presentation. For example, the terms in a search query can be classified as a categorization of the instances that are to appear in a structured presentation based on, e.g., the particular terms in the search query, an express indication by the user as to how search query terms are to be classified, and/or the context of the search. By way of example, the terms in a search query “cities in California” can be classified as a categorization of instances such as “San Diego,” “Los Angeles,” and “Bakersfield” due to the plural term “cities” being characterized by an attribute, namely, being “in California.” As another example, the terms in a search query “Ivy League schools” can be classified as categorization of instances (such as “Cornell,” “Columbia,” and “Brown”) due to the plural term “cities” being characterized by an attribute “Ivy League.”

In some cases, additional information must be used to classify the terms in a search query. For example, the search query “Ivy League” can reasonably be taken as a categorization of school instances or as an example instance of the category “athletic conferences” which includes instances such as “Atlantic Coast Conference” and “PAC-10.” In such cases, the terms can be classified, e.g., based on an express indication by the user as to how they are to be classified or based on the context of the terms in a search session. For example, if a user had previously entered the phrases “Atlantic Coast Conference” and “PAC-10” as search queries, the search query “Ivy League” can be taken as an example instance that is to appear in a structured presentation alongside those other instances.

The documents can be identified either directly in electronic document collection 102 or indirectly based on information in electronic data center 208. Such identifying information can include, e.g., the URL where the document was found the last time it was crawled.

FIG. 8 is a flow chart of another example process 800 for identifying two or more responsive documents in an electronic document collection. Process 800 can be performed in isolation or in conjunction with other data processing activities. For example, process 800 can be performed at step 605 in process 600 (FIG. 6). As another example, process 800 can be performed in conjunction with process 700 at step 605 in process 600 (FIG. 6). For example, processes 700, 800 can be part of an iterative, interactive process in which a search query is received and used to identify a first collection of responsive documents, a first structured presentation that includes content drawn from the identified documents is presented to a user, user modifications are received, and a description of the modified structured presentation is used to identify a second collection of relevant documents. In some implementations, process 800 can be performed several times. In some implementations, process 800 can be performed without user input, e.g., by crawler 206 in system 200 (FIG. 2).

The system performing process 800 receives a description of existing content of a structured presentation (step 805). In particular, the system can receive a description of the instances, the attributes, the values, and/or the units in which values are presented in an existing structured presentation. The description can include, e.g., identifiers of the instances and the attributes and/or ranges of the values of the attributes. The description can also include a categorization of the instances and/or attributes. Such a categorization can be determined, e.g., using an ontology or based on a categorization assigned by a viewer to a structured presentation. For example, if a user entitles a structured presentation “Ivy League Schools,” then this title can be taken as a categorization of the instances in that structured presentation.

In response, the system performing process 800 can identify one or more documents that contain instances, attributes, and/or values that are relevant to the existing content (step 810). For example, the system can compare the identifiers of instances and/or attributes to indexed keywords to determine if particular documents contains one or more of the instances and/or attributes that already appear in the existing content of a structured presentation. As another example, the system can identify new instances, their attributes, and the values of such attributes from such documents, compare these values to values that already appear in the existing content of a structured presentation, and determine whether the new instances are potentially relevant to the to the existing content of the structured presentation.

The documents can be identified either directly in electronic document collection 102 or using identifying information in electronic data center 208. Such identifying information can include, e.g., the memory location where the document was found the last time it was crawled.

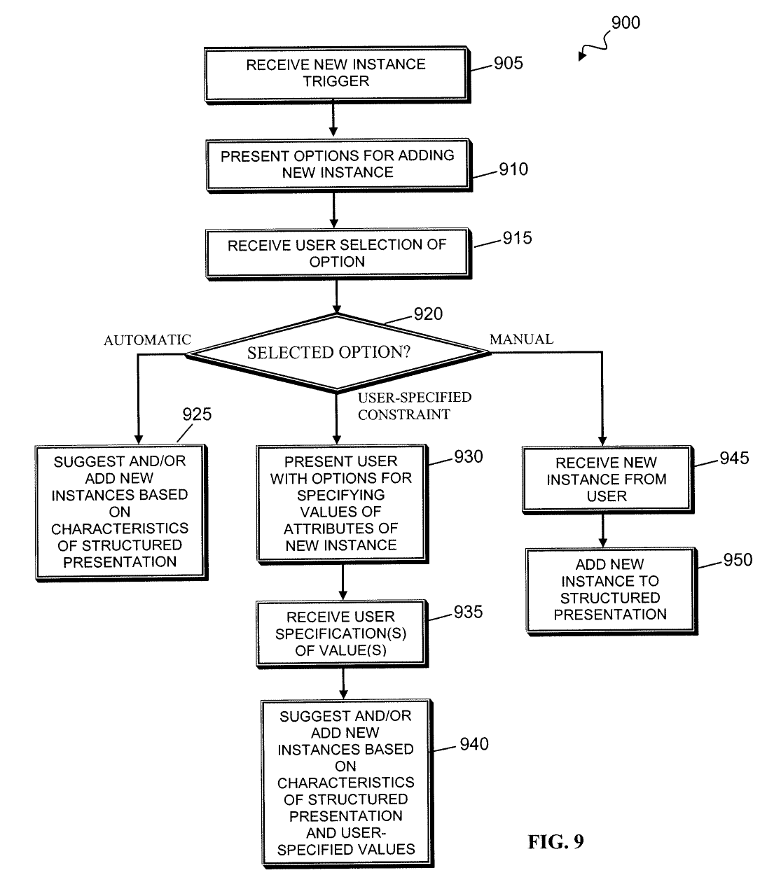

FIG. 9 is a flow chart of a process 900 for suggesting and/or adding new instances to a structured presentation. Process 900 can be performed by one or more computers that perform operations by executing one or more sets of machine-readable instructions. These digital data processing devices can interact with a user over input and output devices, such as keyboards, mice, touchscreens, displays screens, and the like. For example, in the context of system 200 (FIG. 2), user interaction in process 900 can be performed at clients such and PDA 215 or desktop computer 217.

Process 900 can be performed alone or in conjunction with other data processing activities. For example, as discussed further below, process 900 can be performed in conjunction with various processes for formulating instance suggestions for addition to a preexisting structured presentation. Examples of such formulation processes are described in the disclosures entitled “ADDING NEW INSTANCES TO A STRUCTURED PRESENTATION” (Attorney Docket No. 16113-1219001), the contents of both of which are incorporated herein by reference. In general, process 900 will be performed by multiple digital data processing devices. For example, in the context of system 200 (FIG. 2), activities for formulating instance suggestions can be performed at search engine 202 while user interaction can occur at clients such and PDA 215 or desktop computer 217 (FIG. 2).

The system performing process 900 can receive a new instance trigger (step 905). A new instance is an instance that is not currently displayed in a structured presentation, such as structured presentation 106 (FIG. 1). A new instance trigger is an event that activates the processes for adding a new instance to a structured presentation. For example, a new instance can be triggered by user input received over a mouse, stylus, keyboard, or the like. In other implementations, a new instance can be triggered by another process or system. A new instance trigger can be received through inter-process communication or an application's message handler, to name two examples.

The system performing process 900 can present, to a user, options for adding new instances to a structured presentation (step 910). Options are alternative approaches for adding new instances. Example options include fully automatic options, automatic options with user-specified constraints, and manual options. These options are discussed in further detail below.

The system performing process 900 can present options to a user using a user interface such as a display screen. In many cases, the display screen that presents the options can be the same display screen that presents the structured presentation to which the instances are to be added. For example, options can be presented to a user using a display screen 104 (FIG. 1).

The system performing process 900 can receive user selection of an option (step 915). The user selection can be received using one or more input devices, such as a keyboard, touchpad, or touchscreen. The system can also determine the nature of the option selected by the user (step 920).

If the system performing process 900 determines that the user has selected an “automatic option,” then the system can suggest and/or add additional instances to the structured presentation automatically, without interaction with a user.

In one implementation of a user-specified automatic option, the new instances can be suggested and/or added based on the characteristics of the structured presentation (step 925). Examples of such characteristics include the nature of the instances already specified in the structured presentation, categorizations of those instances, and the attributes of those instances. Approaches for formulating new instances based on such characteristics are described in the disclosures entitled “ADDING NEW INSTANCES TO A STRUCTURED PRESENTATION” (Attorney Docket No. 16113-1219001). For example, as described therein, search queries can be constructed using attribute identifiers drawn from the preexisting structured presentation, attribute values drawn from the preexisting structured presentation, and/or combinations thereof. These search queries can be used to identify instances for addition to the structured presentation using string comparisons or other matching techniques.

If the system performing process 900 determines that the user has selected an “user-specified constraint” option, then the system can suggest and/or add additional instances to the structured presentation automatically based on user-specified constraints on the nature of the additional instances. The constraints can be expressed as one or more parameters that characterize the suggested and/or added instances. For example, the constraints can be expressed as the acceptable value of an attribute of the instances or as a range of acceptable values of an attribute.

In one implementation of a user-specified constraint option, the system performing process 900 presents a user with options for constraining values of attributes of new instances (step 930). For example, the system can display a list of attributes that characterize the instances in a structured presentation as well as input fields that allow a user to input constraints on the values of those attributes. Often, the attributes in such a list also appear in the structured presentation to which the new instances are to be added. However, in some implementations, the attributes in such a list can be formulated based on the attributes used to characterize the instances elsewhere, such as in the documents of an electronic document collection. Example approaches for formulating such attributes are described in the disclosure entitled “ADDING NEW ATTRIBUTES TO A STRUCTURED PRESENTATION” (Attorney Docket No. 16113-1220001).

The system performing process 900 can also receive a user specification of one or more constraints on the values of attributes of the new instances (step 935). As discussed above, the constraints can limit the values of one or more attributes to a specific value or to a range of values. For example, one attribute that characterizes cars is “number of cylinders.” A user specified constraint of the values of this attribute can limit the number of cylinders of new car instances to a specific value (e.g., “six”) or to a range of values (e.g., “six to eight” or “more than six”).

The system performing process 900 can also suggest and/or add new instances based on the user-specified constraints and on characteristics of the structured presentation (step 940). Examples of characteristics of a structured presentation include the nature of the instances already specified in the structured presentation, categorizations of those instances, and the attributes of those instances. Approaches for formulating new instances based on such characteristics are described in the disclosures entitled “ADDING NEW ATTRIBUTES TO A STRUCTURED PRESENTATION” (Attorney Docket No. 16113-1220001). As another example, search queries can be constructed using attribute identifiers drawn from the preexisting structured presentation, attribute values drawn from the preexisting structured presentation, and/or combinations, as well as the constraints specified by a user. These search queries can be used to identify instances using string comparisons or other matching techniques. The identified instances can then be suggested and/or added to the structured presentation.

If the system performing process 900 determines that the user has selected a “manual option,” then the system can add additional instances to the structured presentation under the direction of a user.

In one implementation of a manual option, the system performing process 900 can receive a new instance from the user (step 945). For example, the user can input an instance name using a keyboard or other user input device. The system performing process 900 can add the new instance to the structured presentation (step 950). In general, the name of a new instance can be added directly to the structured presentation as instance identifier 306 in a new structured record 310. In some implementations, the new structured record 310 can be a new row 302 (FIGS. 3, 4) or a new card 502 (FIG. 5).

In some implementations, the system performing process 900 can also perform additional operations based on the received new instance. For example, the system can use a new instance to refine the set of suggested instances or a set of suggested attributes.

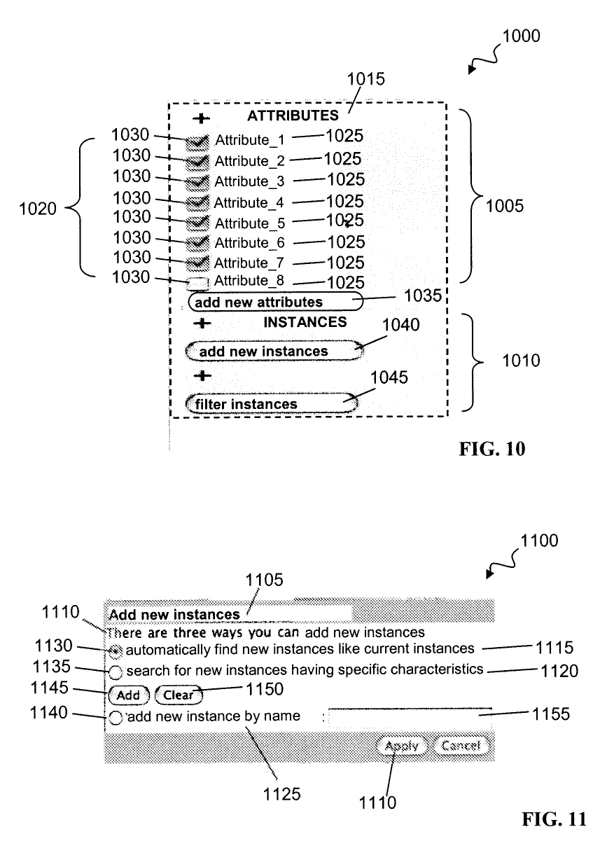

FIG. 10 is a schematic representation of a user interface component 1000 for receiving user input specifying modifications of a structured presentation. For example, user interface component 1000 can be used to receive a new instance trigger at step 905 in process 900 (FIG. 9).

User interface component 1000 includes an attribute modification region 1005 and an instance modification region 1010. Attribute modification region 1005 includes a header 1015, a collection 1020 of attribute identifiers 1025, each of which is associated with an attribute identifier selection widget 1030, and a new attribute addition trigger 1035.

Header 1015 includes text or other information that identifies that user interaction with attribute modification region 1005 will indeed allow the user to modify attributes. Attribute identifiers 1025 are text or other information that identifies attributes to be included in a structured presentation. For example, attribute identifiers 1025 can be the same text that appears as attribute identifiers 308 in structured presentations 300, 400, 500 (FIGS. 3, 4, 5). Attribute identifier selection widget 1030 is an interactive display element that allows users to select and deselect attributes for display in structured presentations. For example, in collection 1020, each attribute identifier selection widget 1030 is associated with a single attribute identifier 1025 by virtue of their arrangement and positioning adjacent one another. Attribute identifier selection widgets 1030 can indicate whether an attribute identifier 1025 is selected or deselected for display using one or more graphical indicia, such as the checks and coloring shown. For example, if a user interacts with the checked attribute identifier selection widget 1030 associated with attribute identifier 1025 “Attribute_{—}1,” the color and checked status in attribute identifier selection widget 1030 is changed and the removal of an attribute identifier associated with “Attribute_{—}1” (as well as the values corresponding to “Attribute_{—}1”) from a structured presentation is triggered.

New attribute addition trigger 1035 is an interactive display element by which a user can trigger the addition of a new attribute to a structured presentation. The formulation of new attributes for addition is described in more detail in the disclosures entitled “ADDING NEW ATTRIBUTES TO A STRUCTURED PRESENTATION” (Attorney Docket No. 16113-1220001). The addition of new attributes is also described in more detail below, e.g., in FIGS. 13-15.

Instance modification region 1010 includes a new instance addition trigger 1040 and an instance filter trigger 1045. New instance addition trigger 1040 is an interactive display element by which a user can trigger the addition of a new instance to a structured presentation. For example, new instance addition trigger 1040 can be used at step 905 in process 900 (FIG. 9).

Instance filter trigger 1045 is an interactive display element by which a user can trigger the filtering of instances in a structured presentation. Filtering instances yields a collection of instances that satisfy one or more criteria. For example, filtering can yield a collection of instances that have certain values, or values within a designated range. Filtering can thus reduce the number of instances to be included in a structured presentation.

The filtering triggered by instance filter trigger 1045 can include the presentation of a user interface component that allows a user to specify one or more filtering criteria and modifying a structured presentation so that instances which fail to meet the criteria are not displayed.

In some implementations, user interface component 1000 can respond dynamically to modifications made by a user using user interface component 1000 or otherwise. For example, if the user triggers and adds a new attribute to a structured presentation, an identifier of that new attribute can be added to collection 1020 and presented in user interface component 1000. For example, if the user adds “Attribute_{—}9” to the structured presentation, the attribute identifier “Attribute_{—}9” can be added to user interface component 1000 with an associated action trigger 1030.

FIG. 11 is schematic representation of a user interface component 1100 for receiving user input specifying a technique for adding new instances to a structured presentation. For example, user interface component 1100 can be used to present options for adding new instances to a structured presentation at step 910 and to receive a user selection of a option at step 915 in process 900 (FIG. 9).

User interface component 1100 includes a header 1105, a prompt 1110, a collection of descriptions of techniques for adding new instances to a structured presentation 1115, 1120, 1125, each of which is associated with a selection widget 1130, 1135, 1140.

Header 1105 includes text or other information that identifies that user interaction with user interface component 1100 will indeed allow the user to specify a technique for adding new instances. Prompt 1110 prompts a user to interact with user interface component 1100 to specify a technique for adding new instances.

Description 1115 describes that user specification of this technique will result in new instances being added by a user-specified constraint option. User interaction with selection widget 1130 allows a user to specify the user-specified constraint option described by description 1115.

Description 1120 describes that user specification of this technique will result in new instances being added by a user-specified constraint option. Description 1120 includes a constraint addition widget 1145 and a constraint clear widget 1150. User interaction with constraint addition widget 1145 triggers the addition of new constraint that is to be used in the user-specified constraint option. User interaction with constraint clear widget 1150 clears all current constraints. User interaction with selection widget 1135 allows a user to specify the user-specified constraint option described by description 1120.

Description 1125 describes that user specification of this technique will result in new instances being added by a manual option. Description 1125 includes a new instance identifier input field 1155. User interaction with new instance identifier input field 1155 allows a user to identify a new instance, e.g., by name. User interaction with selection widget 1140 allows a user to specify the manual option described by description 1125.

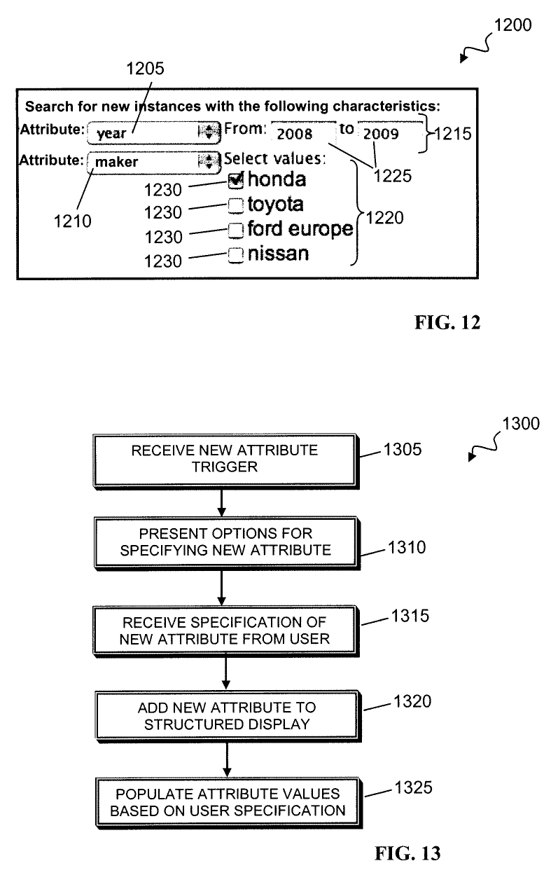

FIG. 12 is schematic representation of a user interface component 1200 for receiving user input specifying constraints that are to be used in the user-specified constraint option for adding new instances to a structured presentation. User interface component 1200 can be used in isolation (e.g., on a dedicated window or portal) or in conjunction with other user interface component. For example, user interface component 1200 can be inserted into user interface component 1100 immediately below technique description 1120 (FIG. 11). For example, user interface component 1200 can be used to present options for specifying values of attributes of new instances that are to be added to a structured presentation at step 930 and to receive a user specification of such values of attributes at step 935 in process 900 (FIG. 9).

User interface component 1200 includes a collection of one or more attribute selection widgets 1205, 1210, each of which is associated with a value specification region 1215, 1220. Attribute selection widgets 1205, 1210 are interactive display elements that allow a user to select an attribute whose values are to be constrained. In the illustrated implementation, each attribute selection widget 1205, 1210 is drop-down box widget that lists identifiers of attributes. In some implementations, the listed attribute identifiers can be identical to the attribute identifiers 308 in a structured presentation to which the new instance is to be added.

Value specification regions 1215, 1220 are interactive display elements that allow a user to specify one or more constraints on the value of the attribute identified in the respective of attribute selection widgets 1205, 1210. In the illustrated implementation, value specification region 1215 includes a pair of text entry fields 1225 that allow a user to specify an acceptable range of values of the attribute identified in attribute selection widget 1205. Value specification region 1220 includes a collection of interactive check boxes 1230 that allow a user to specify an acceptable value of the attribute identified in attribute selection widget 1210.

In operation, user selection of a particular attribute identifier using an attribute selection widget 1205, 1210 can trigger a change in the associated value specification region 1215, 1220. For example, the nature of any interactive elements and the values and/or ranges that can be specified in the associated value specification region 1215, 1220 can be changed. In some implementations, these changes can be based on the distribution of values of such attributes in the structured presentation to which the new instance is to be added. For example, if only four values of the attribute “maker” appear in the structured presentation, these same four values can be presented for specification in the associated value specification region. In other implementations, the changes to the associated value specification region 1215, 1220 can be based on the values of the attribute that characterize similar instances in an electronic document collection 102. For example, the attribute “maker” of instances of cars may be characterized in documents in electronic document collection 102 using a wider variety of values. These values can be identified and presented for specification in the associated value specification region.

FIG. 13 is a flow chart of an example process 1300 for adding new attributes to a structured presentation. Process 1300 can be performed by one or more computers that perform operations by executing one or more sets of machine-readable instructions. These digital data processing devices can interact with a user over input and output devices, such as keyboards, mice, touchscreens, displays screens, and the like. For example, in the context of system 200 (FIG. 2), user interaction in process 1300 can be performed at clients such and PDA 215 or desktop computer 217.

Process 1300 can be performed alone or in conjunction with other data processing activities. For example, as discussed further below, process 1300 can be performed in conjunction with various processes for formulating attribute suggestions for addition to a preexisting structured presentation. Examples of such formulation processes are described in the disclosures entitled “ADDING NEW ATTRIBUTES TO A STRUCTURED PRESENTATION” (Attorney Docket No. 16113-1220001) and “ADDING NEW INSTANCES TO A STRUCTURED PRESENTATION” (Attorney Docket No. 16113-1219001). In general, process 1300 will be performed by multiple digital data processing devices. For example, in the context of system 200 (FIG. 2), activities for formulating attribute suggestions can be performed at search engine 202 while user interaction can occur at clients such and PDA 215 or desktop computer 217 (FIG. 2).

The system performing process 1300 can receive a new attribute trigger (step 1305). A new attribute is an attribute that is not currently displayed in a structured presentation, such as structured presentation 106 (FIG. 1). A new attribute trigger is an event that activates the processes for adding a new attribute to a structured presentation. For example, a new attribute can be triggered by user input received over a mouse, stylus, keyboard, or the like. In other implementations, a new attribute can be triggered by another process or system. A new attribute trigger can be received through inter-process communication or an application's message handler, to name two examples. For example, in some implementations, the system can receive a new attribute trigger from the user interface component 1000 through user selection of new attribute addition trigger 1035 (FIG. 10).

The system performing process 1300 can present options for specifying new attributes (step 1310). For example, the system can display a list of new attributes that are used to characterize the instances in a structured presentation as well as interactive display elements that allow a user select one or more of those attributes. In some implementations, the attributes in such a list can be formulated based on the attributes used to characterize the instances elsewhere, such as in the documents of an electronic document collection. Example approaches for formulating such attributes are described in the disclosure entitled “ADDING NEW ATTRIBUTES TO A STRUCTURED PRESENTATION” (Attorney Docket No. 16113-1220001).

The system performing process 1300 can receive a specification of a new attribute from a user (step 1315). The specification of an attribute can characterize traits or characteristics of the new attribute, including, e.g., the name or other identifier of the new attribute, keywords associated with the new attribute, trustworthy sources of information regarding the new attribute, and the like. The specification of an attribute can be received from the user over one or more input devices, such as a keyboard, touchpad, or touchscreen.

The system performing process 1300 can add the specified new attributes to a structured presentation (step 1320). For example, the system performing process 1300 can add a new attribute identifier 308 and column 304 to tables 300, 400 (FIGS. 3, 4). As another example, the system can add a new attribute identifier 308 into column 504, along with a corresponding attribute value 307 in column 506 of card collection 500 (FIG. 5). In some implementations, the system performing process 1300 can also add the new attribute not only to a structured presentation but also to a user interface component for receiving user input specifying modifications of a structured presentation. For example, the system can add the new attribute to attribute modification region 1005 of user interface component 1000 (FIG. 10).

The system performing process 1300 can populate the attribute values based at least in part on the user specification (step 1325). The system can populate the attribute values using various techniques, as described in further detail below.

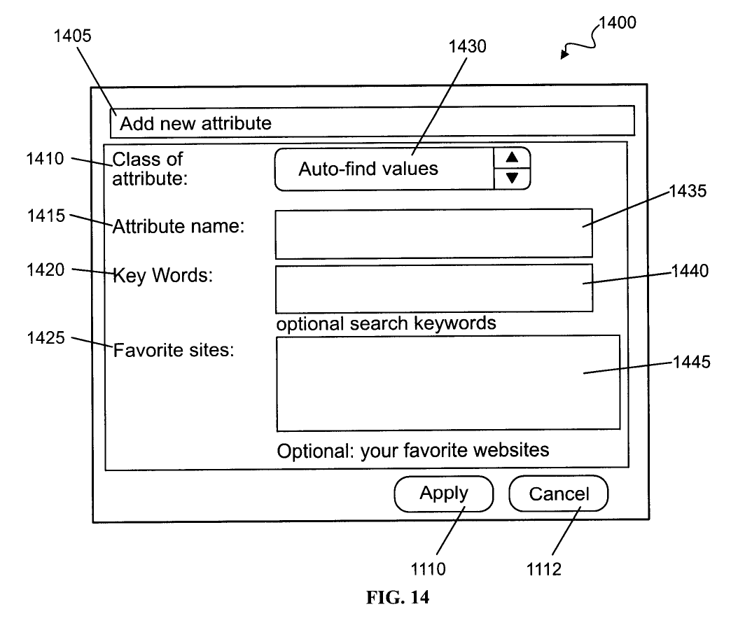

FIG. 14 is schematic representation of a user interface component 1400 for adding new attributes to a structured presentation. User interface component 1400 can interact with a user for the specification of one or more traits or characteristics of the new attribute. These traits or characteristics can be used, e.g., in adding new attributes and attribute values to a structured presentation. For example, user interface component 1400 can be used to present options for adding a new attribute class to a structured presentation at step 1310 and to receive a user specification of a new attribute at step 1315 in process 1300 (FIG. 13).

User interface component 1400 includes a header 1405 and a collection of trait identifiers 1410, 1415, 1420, 1425 that identify traits that characterize the new attribute. Each trait identifier 1410, 1415, 1420, 1425 is associated with a trait specification widget 1410, 1415, 1420, 1425 and identifies the trait that can be specified by user interaction with that widget. Header 1405 includes text or other information that identifies that user interaction with user interface component 1400 will indeed allow the user to add a new attribute to a structured presentation.

Trait identifier 1410 identifies that a user can specify a class of the attribute to be added to a structured presentation by interacting with trait specification widget 1430. The class of an attribute indicates how the attribute and its values are to be identified. For example, an attribute class can specify a technique by which the attribute and its values to be identified in an electronic document collection. Example attribute classes include “auto-find values,” “search results,” “review,” and “note” classes. Details regarding these attribute classes are discussed further below. Trait specification widget 1430 is an interactive display element that allows a user to specify the class of the attribute to be added to a structured presentation. In the illustrated implementation, trait specification widget 1430 is a drop-down box widget.

Trait identifier 1415 identifies that a user can specify a name or other identifier of the new attribute by interacting with trait specification widget 1435. Trait specification widget 1435 is an interactive display element that allows a user to specify the name or other identifier of the new attribute to be added to a structured presentation. In the illustrated implementation, trait specification widget 1435 includes a text entry field. In general, the attribute identifier identified in trait identifier 1415 can be added directly into a structured presentation as an attribute identifier 308.

Trait identifier 1420 identifies that a user can specify keywords that that characterize the new attribute by interacting with trait specification widget 1440. Trait specification widget 1440 is an interactive display element that allows a user to specify one or more keywords that characterize the attribute to be added to a structured presentation. In the illustrated implementation, trait specification widget 1440 includes a text entry field into which one or more keywords can be entered. The keywords can include, e.g., synonyms of the attribute identifier or terms that characterize the context of the attribute identifier. For example, if the attribute identifier is “bank,” the keywords identified in trait specification widget 1440 can include “NASCAR” and “speedway” to indicate that the attribute refers to the “bank” of a racetrack as opposed to a financial institution.

In operation, the keywords specified in trait specification widget 1440 can be used to identify instances, attributes, and/or attribute values in searches of electronic document collections. For example, the keywords can be used when formulating new attributes and/or new instances, as described in the disclosures entitled “ADDING NEW INSTANCES TO A STRUCTURED PRESENTATION” (Attorney Docket No. 16113-1219001) and “ADDING NEW ATTRIBUTES TO A STRUCTURED PRESENTATION” (Attorney Docket No. 16113-1220001).

Trait identifier 1425 identifies that a user can specify “favorite sites” that characterize the new attribute by interacting with trait specification widget 1445. “Favorite sites” are documents in an electronic document collection. User specification of a document as a “favorite site” is indicative that the user considers the content of the document to be both being relevant to the new attribute and likely to be true. The content of a “favorite site” can thus be assigned a high confidence value, e.g., in formulating new instances and new attributes for addition to a preexisting structured presentation (as discussed further below). User specification of a document as a “favorite sites” can also be used as an indication that the content of the document is a trustworthy of attribute values for populating a structured presentation.

Trait specification widget 1445 is an interactive display element that allows a user to specify one or more documents in an electronic document collection as “favorite sites.” In the illustrated implementation, trait specification widget 1445 includes a text entry field into which, e.g., one or more domain names or other electronic document locations can be entered.

In some implementations, a trait “de-specification” widget allows a user to identify that one or more documents in an electronic document collection are “disfavored” sites. User specification of a document as a “disfavored site” indicates that the user does not trust the document as a source of attribute values. Such a trait de-specification widget can includes a text entry field into which, e.g., one or more domain names or other electronic document locations can be entered.

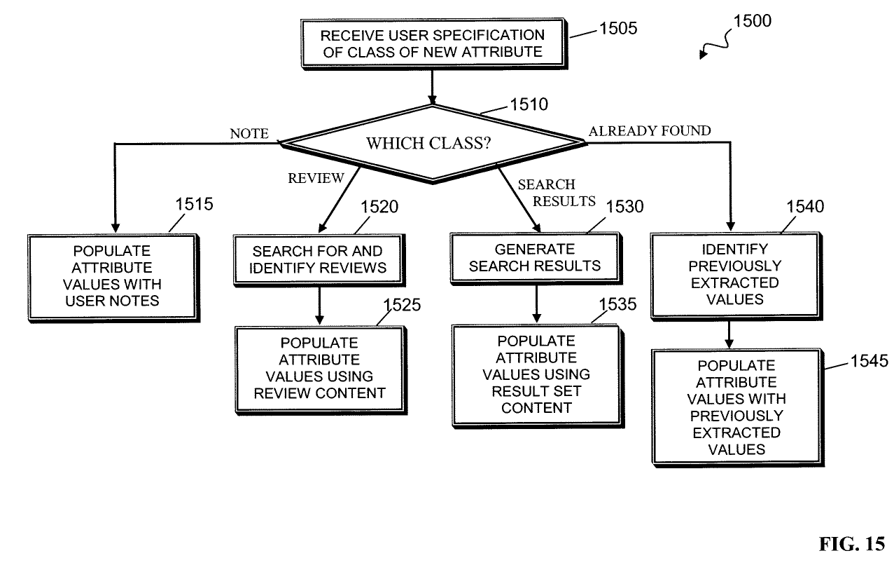

FIG. 15 is a flow chart of an example process 1500 for adding new attribute values to a structured presentation. Process 1500 can be performed by one or more computers that perform operations by executing one or more sets of machine-readable instructions. Process 1500 can be performed alone or in conjunction with other data processing activities. For example, as discussed further below, process 1500 can be performed in conjunction with various processes for adding new attributes to a structured presentation, such as process 1300 (FIG. 13).

The system performing process 1500 can receive user specification of the class of a new attribute (step 1505). As discussed above, the class of an attribute indicates how the attribute and its values are to be identified. The receipt of the class of a new attribute can be part of the receipt of a specification of a new attribute at step 1315 in process 1300 (FIG. 13). In some implementations, the user specification of the class of a new attribute can be received over trait specification widget 1430 in user interface component 1400 (FIG. 14).

The system performing process 1500 can determine which class is specified for the new attribute (step 1510). Based on the class specified, the system performing process 1500 can determine which of various subprocesses for adding new attribute values to the structured presentation is to be performed. For example, the system can determine to add attribute values in accordance with a subprocess associated with a “note” class, a subprocess associated with a “reviews” class, a subprocess associated with a “search results” class, or a subprocess associated with an “already found” class.

If the system performing process 1500 determines to add new attribute values using a subprocess associated with the “note” class, the system can populate attribute values with notes received from the user (step 1515). For example, in the context of FIG. 4, values in the notes column 420 in table 400 can be received from a user and used to populate the values of a new attribute.

If the system performing process 1500 determines to add new attribute values using a subprocess associated with the “reviews” class, the system can search for and identify electronic documents that include reviews (step 1520). Reviews are critical evaluations of one or more instances characterized by the new attribute. In some cases, reviews can be authored by someone with expertise in evaluating instances, such as a critic. Reviews can be identified, e.g., based on a label or other text that identifies them as reviews. For example, certain domain names (e.g., http://www.google.com/prdhp, http://www.epinions.com/, http://www.amazon.com/) can be used to identify electronic documents that include reviews. The electronic documents that include reviews can be found in an electronic document collection, such as collection 102.

The system performing process 1500 can populate attribute values using content from the identified reviews (step 1525). For example, the system can extract values from the review using one or more text- or table-based extraction patterns and present those extracted values in the structured presentation. These extraction patterns may preferentially select segments of the review documents that are “sentiment focused.” Sentiment focused segments are identified as voicing strong sentiments, either positive or negative, about certain subject matter. For example, a review of a restaurant could include a sentiment focused segments such as “the food is exceptionally good” and “the service was very poor indeed.” The presentation of those extracted values in the structured presentation can be part of a population of a structured presentation at step 1325 in process 1300 (FIG. 13).

If the system performing process 1500 determines to add new attribute values using a subprocess associated with the “search results” class, the system can generate a collection of search results from an electronic document collection, such as collection 102 (step 1530). The search can yield a result set that is not limited to reviews but rather can include a variety of electronic documents. The electronic documents can be found in an electronic document collection such as collection 102.

The search results can be generated by searching based on an identifier of the new attribute, as well as the identifiers of instances characterized by that attribute. In some implementations, additional keywords that are associated with the new attribute can be used to refine search results, such as the keywords received from the user over trait specification widget 1440 of user interface component 1400 (FIG. 14).

The system performing process 1500 can populate attribute values in the structured presentation with content from the search result set (1535). For example, the system can extract one or more values from the search result set using one or more text- or table-based extraction patterns and present those extracted values in the structured presentation. The population of those attribute values with the content of the search result set can be part of a population of a structured presentation at step 1325 in process 1300 (FIG. 13).

If the system performing process 1500 determines to add new attribute values using a subprocess associated with the “already found” class, the system can identify values that have already been found and extracted from an electronic document collection such as electronic document collection 102 (step 1540). The “already found” values can be stored, e.g., in a collection of information that characterizes the electronic documents, such as data center 208 in system 200 (FIG. 2). In some implementations, such a collection of information can include a historical record of previous structured presentations. The system performing process 1500 can populate attribute values of a structured presentation with the previously extracted values (step 1545). The population of those attribute values with the content of the search result set can be part of a population of a structured presentation at step 1325 in process 1300 (FIG. 13).

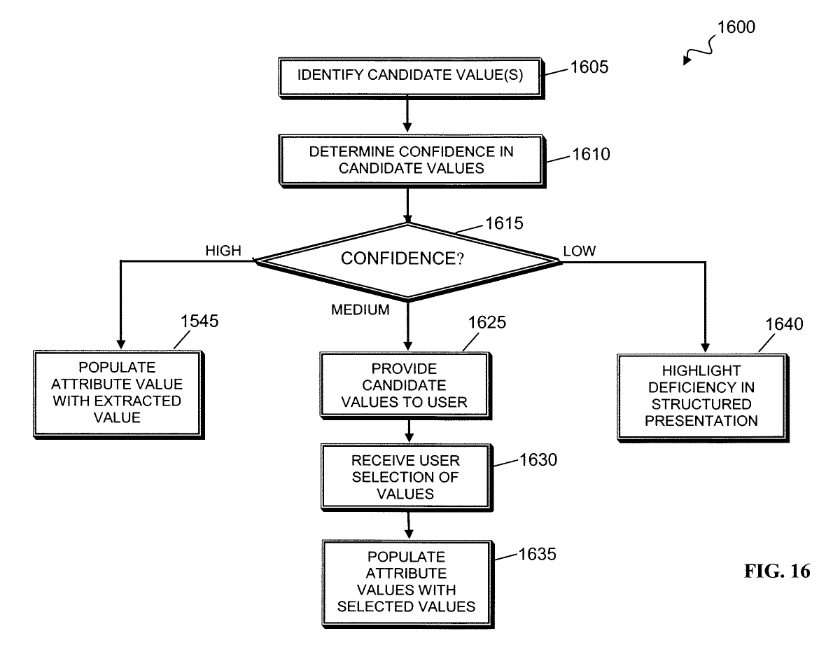

FIG. 16 is a flow chart of an example process 1600 for adding new attribute values to a structured presentation. In particular, process 1600 is concerned with selecting attribute values to be used in populating the attribute values of a structured presentation. Process 1600 can be performed by one or more computers that perform operations by executing one or more sets of machine-readable instructions. Process 1600 can be performed alone or in conjunction with other data processing activities. For example, process 1600 can be performed at step 1325 in process 1300 (FIG. 13), at step 1525 in process 1500 (FIG. 15), at step 1535 in process 1500 (FIG. 15), and/or at step 1545 in process 1500 (FIG. 15).

The system performing process 1600 can identify candidate attribute values (step 1605). The candidate attribute values can be, e.g., extracted directly from content (such as reviews or other documents in an electronic document collection) or identified from a collection of previously-extracted attribute values. For example, in the context of FIG. 2, the system can access data center 208 and extract one or more stored attribute values.

The system performing process 1600 can determine a confidence in the identified candidate values (step 1610). The confidence in a candidate value should characterize the degree of assurance that the candidate value correctly characterizes the attribute of an instance. The confidence in the correctness of a value can be determined based on, e.g., the number of times that the value is used to characterize an attribute of an instance, the quality of the documents from which the value is used to characterize an attribute of an instance, and the like.

The system performing process 1600 can determine whether the confidence in certain of the candidate values is low, medium, or high (step 1615). A low confidence in an attribute value indicates that it is unlikely that the candidate value correctly characterizes the attribute of an instance. A high confidence in an attribute value indicates that it is likely that the candidate value correctly characterizes the attribute of an instance.

Is the system performing process 1600 determines that the confidence in certain of the candidate values is high, then the system can populate attribute values in the structured presentation with the extracted values (step 1545). This can be done automatically, i.e., without input from a user.

If the system performing process 1600 determines that the confidence in certain of the candidate values is medium, then the system can provide the candidate values to the user (step 1625). For example, the system can generate a user interface component that presents candidate values in association with identifiers of the instances and the attributes potentially characterized by those candidate values.

The system performing process 1600 can receive user selections of certain of the presented values (step 1630). The user selection can be received as one or more user inputs. For example, a user interface component that presents candidate values can include one or more selection widgets that allow the user to select candidate values for populating a structured presentation. The selection can be received from a user using a mouse, keyboard or other user input device.

The system performing process 1600 can populate the attribute value with the selected values (step 1635). For example, the system performing process 1600 can present the selected value in the structured presentation.

In some implementations, the selected attribute values can be used to further refine the attributes, values, and/or instances presented in the structured presentation. For example, if a user specifies that the value of an attribute of an instances is several thousand dollars, the magnitude of the value can be used to exclude values of significantly different magnitude from the structured presentation. As another example, if a user specifies that the value of an attribute of an instances is several thousand dollars, the magnitude of the value can be used to exclude instances that have values of that attribute that are significantly different in magnitude.

If the system performing process 1600 determines that the confidence in certain of the candidate values is low, then the system performing process 1600 can highlight such deficiencies in the structured presentation (step 1640). The deficiencies can be highlighted, e.g., by leaving an open entry or by highlighting the low confidence values using colored or other indicia. The system may also be able to receive candidate values that remedy these deficiencies from a user who interacts with an interactive element such as, e.g., a text field in the open entry or a notes cell adjacent the deficient entry.

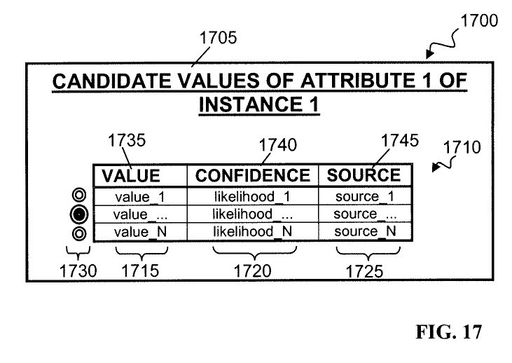

FIG. 17 is a schematic representation of a user interface component 1700 for selecting a candidate value to be added to a structured presentation. User interface component 1700 can interact with a user for the selection of a value that is to characterize a new attribute in the structured presentation. For example, user interface component 1700 can be presented to a user at step 1625 and receive a user selection at step 1630 of process 1600 (FIG. 16).

The user interface component 1700 includes a header 1705 and a table 1710. Header 1705 includes text or other information that identifies that user interaction with user interface component 1700 will allow the user to select a value of an attribute of an instance for display in a structured presentation. Table 1710 includes a collection of candidate value information organized into columns 1715, 1720, 1725, as well as a collection of row selection widgets 1730.

In particular, column 1715 includes a column header 1735 as well as a collection of candidate value identifiers. The candidate value identifiers can have been extracted directly from document the electronic document collection 102 or indirectly over data center 208. In some implementations, the values may also include unit identifiers 309 that specify the unit of measure for the particular value 307. Column header 1735 identifies that candidate value identifiers are found in column 1715.

Column 1720 includes a column header 1740 as well as a collection of confidence values. The confidence values indicate the likelihoods that the candidate values identified in column 1715 are correct. The confidence values can be expressed in numerical or word terms. For example, the confidence values can be presented as, e.g., the percentage chance that a value is correct or on a numeric scale. Column header 1740 identifies that confidence values are found in column 1720.

Column 1725 includes a column header 1745 as well as a collection of source identifiers. The source identifiers identify one or more sources of the candidate values identified in column 1715. The sources can be identified using, e.g., the title of an electronic document, a domain name, the author's name, or the like. In some implementations, the source identifiers can include text snippets that include the candidate values identified in column 1715. Column header 1744 identifies that source identifiers are found in column 1720.

Selection widget collection 1730 includes one or more user interactive elements for receiving input from a user. The user input can identify that a candidate value identified in column 1715 is to be added to a structured presentation.

In some implementations, user interface component 1700 can present candidate values in an order that is based on confidence values. For example, a candidate value with the highest confidence value can be presented on the top of column 1715 and the candidate value with the lowest confidence value can be presented on the bottom of column 1715.

In some implementations, user interface component 1700 can also include snippets of text surrounding attributes and values in a particular source identified in column 1725. Such snippets can allow a user to see the value in context.

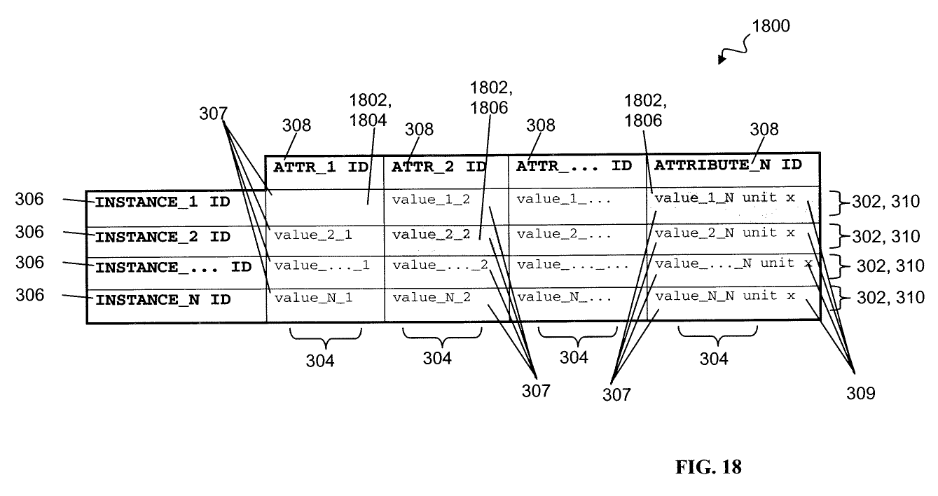

FIG. 18 a schematic representation of a structured presentation 1800 that includes highlights 1802 of deficiencies in the attribute values presented therein. In the illustrated example, the confidence in the values that are candidates for characterizing the attributes “ATTR_{—}1” and “ATTRIBUTE_N” of instance “INSTANCE_{—}1” are low, as is the confidence in the values that are candidates for characterizing the attribute “ATTR_{—}2” of instance “INSTANCE_{—}2.” In the case of attribute “ATTR_{—}1” of instance “INSTANCE_{—}1,” this lack of confidence is highlighted by an empty cell 1804. In the cases of attribute “ATTRIBUTE_N” of instance “INSTANCE_{—}1” and attribute “ATTR_{—}2” of instance “INSTANCE_{—}2,” this lack of confidence is highlighted by a color indicium 1806. Such highlights provide an intuitive form of feedback regarding the nature of particular attribute values. That is, the user can view the table 300 and immediately determine which values may be of questionable correctness. The system can receive user input that remedies one or more of the highlighted deficiencies. For example, the system may receive manually entered attribute values, additional constraints, or other user input described in this specification that the system can use to confidently identify additional attribute values.

In some implementations, user interaction with a cell in which a deficiency is highlighted can trigger a search directed to remedying the deficiency. For example, user interaction with empty cell 1804 can trigger a search. The search can use a customizable query that is based on, e.g., a category of the instances in the display, an identifier of the instance that is to be characterized by the new value, and/or an identifier of the attribute that is to be characterized by the new value. After returning a set search results, a system can receive further interaction that specifies the value that remedies the deficiency. In some implementations, the returned set of search results can include attribute-specific highlighting in text snippets that demarcate potential values.

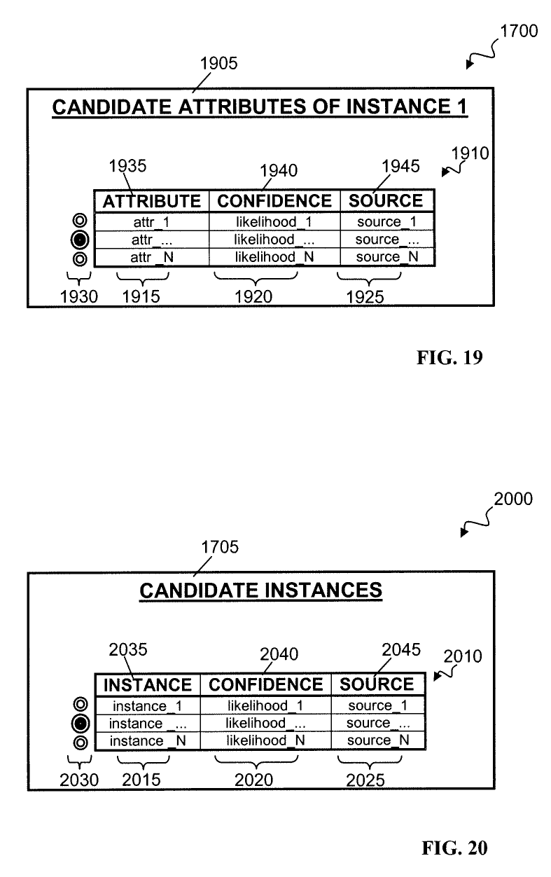

FIG. 19 is a schematic representation of a user interface component 1900 for selecting a candidate attribute to be added to a structured presentation. User interface component 1900 can interact with a user for the selection of an attribute that is to characterize an instance in the structured presentation. For example, user interface component 1900 can be presented to a user to select which attribute is to be added to a structured display at step 1320 of process 1300 (FIG. 13).

The user interface component 1900 includes a header 1905 and a table 1910. Header 1905 includes text or other information that identifies that user interaction with user interface component 1900 will allow the user to select an attribute of an instance for display in a structured presentation. Table 1910 includes a collection of candidate attribute information organized into columns 1915, 1920, 1925, as well as a collection of row selection widgets 1930.

In particular, column 1915 includes a column header 1935 as well as a collection of candidate attribute identifiers. The candidate attribute identifiers can have been extracted directly from document the electronic document collection 102 or indirectly over data center 208. In some implementations, the attributes may also include unit identifiers 309 that specify the units of measure in which values of the candidate attributes are to be cast. Column header 1935 identifies that candidate attribute identifiers are found in column 1915.

Column 1920 includes a column header 1940 as well as a collection of confidence values. The confidence values indicate the likelihoods that the candidate attributes identified in column 1915 are correct. The confidence values can be expressed in numerical or word terms. For example, the confidence values can be presented as, e.g., the percentage chance that an attribute is correct or on a numeric scale. Column header 1940 identifies that confidence values are found in column 1920.

Column 1925 includes a column header 1945 as well as a collection of source identifiers. The source identifiers identify one or more sources of the candidate attributes identified in column 1915. The sources can be identified using, e.g., the title of an electronic document, a domain name, the author's name, or the like. In some implementations, the source identifiers can include text snippets that include the candidate attributes identified in column 1915. Column header 1944 identifies that source identifiers are found in column 1920.

Selection widget collection 1930 includes one or more user interactive elements for receiving input from a user. The user input can identify that a candidate attribute identified in column 1915 is to be added to a structured presentation.

In some implementations, user interface component 1900 can present candidate attributes in an order that is based on confidence values. For example, a candidate attribute with the highest confidence value can be presented on the top of column 1915 and the candidate attribute with the lowest confidence value can be presented on the bottom of column 1915.

In some implementations, user interface component 1900 can also include snippets of text surrounding instances and attributes in a particular source identified in column 1925. Such snippets can allow a user to see the attributes in context.

FIG. 20 is a schematic representation of a user interface component 2000 for selecting a candidate instances to be added to a structured presentation. User interface component 2000 can interact with a user for the selection of an instance that is to be added to a structured presentation. For example, user interface component 2000 can be presented to a user to select which instance is to be added to a structured display at steps 925, 940 of process 900 (FIG. 9).

The user interface component 2000 includes a header 2005 and a table 2010. Header 2005 includes text or other information that identifies that user interaction with user interface component 2000 will allow the user to select an instance for display in a structured presentation. Table 2010 includes a collection of candidate instance information organized into columns 2015, 2020, 2025, as well as a collection of row selection widgets 2030.

In particular, column 2015 includes a column header 2035 as well as a collection of candidate instance identifiers. The candidate instance identifiers can have been extracted directly from document the electronic document collection 102 or indirectly over data center 208. Column header 2035 identifies that candidate instance identifiers are found in column 2015.

Column 2020 includes a column header 2040 as well as a collection of confidence values. The confidence values indicate the likelihoods that the candidate instance identified in column 2015 are to be added. The confidence values can be expressed in numerical or word terms. For example, the confidence values can be presented as, e.g., the percentage chance that an instance is meets with user-specified constraints. Column header 2040 identifies that confidence values are found in column 2020.

Column 2025 includes a column header 2045 as well as a collection of source identifiers. The source identifiers identify one or more sources of the candidate instances identified in column 2015. The sources can be identified using, e.g., the title of an electronic document, a domain name, the author's name, or the like. In some implementations, the source identifiers can include text snippets that include identifiers of the candidate instances in column 2015. Column header 2044 identifies that source identifiers are found in column 2020.

Selection widget collection 2030 includes one or more user interactive elements for receiving input from a user. The user input can identify that a candidate instance identified in column 2015 is to be added to a structured presentation.

In some implementations, user interface component 2000 can present candidate instances in an order that is based on confidence values. For example, a candidate instance with the highest confidence value can be presented on the top of column 2015 and the candidate instance with the lowest confidence value can be presented on the bottom of column 2015.

In some implementations, user interface component 2000 can also include snippets of text surrounding instance identifiers in a particular source identified in column 2025. Such snippets can allow a user to see the instances in context.

The changes made to a structured presentation using the systems and processes described herein can be part of an iterative process in which these changes are used to identify additional instances, attributes, and/or values. For example, process 800 (FIG. 8) can be repeated several times. Since the scope of existing content increases, the additional instances, attributes, and/or values that are identified are likely to be of increased confidence.

Embodiments of the subject matter and the functional operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal that is generated to encode information for transmission to suitable receiver apparatus for execution by data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, or declarative or procedural languages, and it may be deployed in any form, including as a stand alone program or as a module, component, subroutine, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processor suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the following claims. For example, the actions recited in the claims may be performed in a different order and still achieve desirable results. As one example, the processes depicted in the accompanying figures do not necessarily require the particular order shown, or sequential order, to achieve desirable results. Accordingly, other implementations are within the scope of the following claims.

What is claimed is:

1. A machine-implemented method comprising:
receiving a machine-readable search query from a user; and
responding to the search query with instructions for presenting the user with a structured presentation of instances relevant to the search query, wherein a visual presentation of the structured presentation denotes associations between the instances and values that characterize attributes of the instances by virtue of an arrangement of identifiers of the instances and the values, wherein the identifiers of the instances and the values are drawn from two or more documents in an unstructured collection of electronic documents, the electronic document collection being unstructured in that the format of the electronic documents in the electronic document collection is neither restrictive nor permanent.

2. The method of claim 1, wherein responding to the search query comprises:
identifying a first collection of electronic documents in the unstructured collection that relate to the instances;
extracting values of the attributes of the instances from the first collection of electronic documents; and
populating the structured presentation with the values extracted from two or more electronic documents.

3. The method of claim 1, wherein responding to the search query comprises:
extracting a first value of a first attribute of a first instance from a first electronic document;
extracting a second value of a second attribute of the first instance from a second electronic document; and
associating the first value and the second value with the first instance in a single record in the structured presentation,
wherein the first attribute differs from the second attribute and the first electronic document differs from the second electronic document.

4. The method of claim 1, responding to the search query comprises:
extracting a first value of an attribute of a first instance from a first electronic document;
extracting a second value of an attribute of a second instance from the first electronic document;
associating the first value with the first instance in a first record; and
associating the second value in with the second instance in a second record,
wherein the first instance differs from the second instance.

5. The method of claim 1, wherein the structured presentation comprises a table.

6. The method of claim 1, wherein the structured presentation comprises a collection of cards.

7. The method of claim 1, further comprising:
receiving a trigger for the addition of a new instance to the structured presentation; and
suggesting new instances for addition to the structured presentation in response to the trigger.

8. The method of claim 7, wherein:
the method further comprises receiving a specification of a constraint from a user; and
suggesting new instances comprises suggesting new instances that satisfy the user-specified constraint.

9. The method of claim 1, further comprising:
receiving a trigger for the addition of a new attribute to the structured presentation; and
adding a new attribute to the structured presentation in response to the trigger.

10. The method of claim 1, further comprising:
receiving a user specification of a trait of the new attribute; and
populating the structured presentation with values of the attribute based on the user-specified trait.

11. The method of claim 1, wherein the unstructured electronic document collection comprises electronic documents available on the Internet.

12. The method of claim 1, further comprising visually presenting the structured presentation on a display screen, including physically transforming one or more elements of the display screen.

13. An apparatus comprising one or more machine-readable data storage media storing instructions operable to cause one or more data processing machines to perform operations, the operations comprising:
receiving description data describing a preexisting structured presentation, a visual presentation of the preexisting structured presentation visually presenting information in a systematic arrangement that conforms with a structured design, the structured presentation including a collection of records, each of which denotes associations between an instance and values that characterize attributes of the instance by virtue of an arrangement of an identifier of the instance and the values in a visual presentation of the structured presentation;
drawing an identifier of a first instance from a first web site;
drawing a first value of a first attribute of the first instance from a second web site;
adding the identifier of a first instance and the new value to the preexisting structured presentation to form a new record in a new structured presentation; and
outputting instructions for visually presenting the new structured presentation.

14. The apparatus of claim 13, wherein drawing the identifier of the first instance from the first web site comprises comparing characteristics of the preexisting structured presentation with content of the preexisting structured presentation.

15. The apparatus of claim 13, wherein:
the operations further comprise receiving an identifier of a second instance from the user; and
the new structured presentation includes a second new record that presents the second instance in association with a second value of the first attribute of the second instance.

16. The apparatus of claim 15, wherein the operations further comprise receiving the second value from the user.

17. The apparatus of claim 15, wherein the operations further comprise:
presenting a collection of candidate values to the user, wherein the collection includes the second value; and
receiving a selection of the second value from the user.

18. The apparatus of claim 15, wherein the operations further comprise:
identifying a collection of candidate values of the first attribute of the second instance; and
determining, for each of the candidate values, a confidence that the candidate value is correct.

19. The apparatus of claim 13, wherein the operations further comprise suggesting a collection of new instances to be added to the structured presentation.

20. The apparatus of claim 19, wherein suggesting the collection of new instances comprises comparing characteristics of the preexisting structured presentation with content of the first web site and the second web site.

21. The apparatus of claim 19, wherein suggesting the collection of new instances comprises comparing a machine-readable search query with content of the first web site and the second web site.

22. The apparatus of claim 13, wherein drawing the first value from the second web site comprises identifying that the second web site includes a review.

23. The apparatus of claim 13, wherein drawing the identifier from the first web site comprises extracting the identifier directly from the first web site.

24. The apparatus of claim 13, wherein drawing the identifier from the first web site comprises extracting the identifier from a machine-readable database that includes information extracted from the first web site.

25. The apparatus of claim 13, wherein:
the preexisting structured presentation comprises a table; and
the records comprise rows or columns of the table.

26. The apparatus of claim 13, wherein:
the preexisting structured presentation comprises a collection of cards; and
the records comprise individual cards in the collection.

27. The apparatus of claim 13, wherein the operations further comprise visually presenting the new structured presentation on a display screen, including physically transforming one or more elements of the display screen.

28. A system comprising:
a client device; and
one or more computers programmed to interact with the client device and to perform operations comprising:
receiving description data describing a preexisting structured presentation, a visual presentation of the preexisting structured presentation visually presenting information in a systematic arrangement that conforms with a structured design, the structured presentation including a collection of records, each of which denotes associations between an instance and values that characterize attributes of the instance by virtue of an arrangement of an identifier of the instance and the values in a visual presentation of the structured presentation;
drawing an identifier of a first instance from a first web site;
drawing a first value of a first attribute of the first instance from a second web site;
adding the identifier of a first instance and the new value to the preexisting structured presentation to form a new record in a new structured presentation; and
outputting to the client device instructions for visually presenting the new structured presentation.

29. The system of claim 28, wherein the one or more computers comprise a server operable to interact with the client device through a data communication network, and the client device is operable to interact with the server as a client.

30. A system comprising:
a client device; and
one or more computers programmed to interact with the client device and to perform operations comprising:
receiving a machine-readable search query from the client device; and
responding to the search query by sending to the client device instructions for presenting a structured presentation of instances relevant to the search query, wherein a visual presentation of the structured presentation denotes associations between the instances and values that characterize attributes of the instances by virtue of an arrangement of identifiers of the instances and the values, wherein the identifiers of the instances and the values are drawn from two or more documents in an unstructured collection of electronic documents, the electronic document collection being unstructured in that the format of the electronic documents in the electronic document collection is neither restrictive nor permanent.

31. The system of claim 30, wherein the one or more computers comprise a server operable to interact with the client device through a data communication network, and the client device is operable to interact with the server as a client.
